(19) United States
(12) Patent Application Publication
(10) Pub. No.: US 2003/0028728 A1
(43) Pub. Date: Feb. 6, 2003

(54) Cache memory control device

(75) Inventor: Hironobu Ito, Hyogo (JP)

Correspondence Address: McDERMOTT, WILL & EMERY, 600 13th Street, N.W., Washington, DC, 20005-3096, US

(73) Assignee: Mitsubishi Denki Kabushiki Kaisha

(21) Appl. No.: 10/206,756

(22) Filed: Jul. 29, 2002

(30) Foreign Application Priority Data
Jul. 31, 2001 (JP) 2001-231579(P)

(51) Int. Cl. G06F 12/00

(52) U.S. Cl. 711/118; 711/145

(57) ABSTRACT

A specific address region of a cache address region is set in a non-cache region setting register together with a region setting valid bit in a cache memory. When the specific address region is accessed by a CPU core, access to an external memory is made if a corresponding region is set in a non-cache region by a region setting valid bit. Moreover, an invalidating bit is set to invalidate all cache memory data in the specific address region. In DMA transfer, an inclusion detection circuit detects whether a transfer destination address region is included in the set address region and forcibly sets an invalidating bit according to a result of the detection. A cache system is provided that is capable of setting an address region of a cache object region according to a system architecture with flexibility.

### BACKGROUND OF THE INVENTION

1. Field of the Invention

The present invention relates to a cache control device controlling access to a cache memory. More particularly, the present invention relates to a cache memory control unit controlling access to an internal memory embedded in a microprocessor.

2. Description of the Background Art

FIG. 29 is a block diagram schematically showing an example of a configuration of a conventional system using a microprocessor (hereinafter referred to as CPU). In FIG. 29, CPU 290 is coupled with an input/output unit for performing data transfer between CPU 290 and an external memory 283 as well as a device outside the system through an external bus 286. In external memory 283, data used by CPU 290 is stored and external memory 283 is used generally as a main memory. External memory 283 may be a common memory shared with another external device.

CPU 290 is usually integrated on the same semiconductor substrate. CPU 290 includes: a CPU core 1 performing a necessary processing operation; a cache entry table 8 serving as a cache for temporarily storing data stored in external memory 283; a cache control circuit 281 controlling an access operation of CPU core 1 to cache entry table 8 when a data access request is generated from CPU core 1; and a bus control circuit 282 transferring data between external bus 286 and an internal bus 285 under control of cache control circuit 281. Internal bus 285 interconnects CPU core 1, cache entry table 8 and bus control circuit 282 with each other.

In FIG. 29, CPU core 1, cache entry table 8 and bus control circuit 282 are shown being controlled by control signals applied through signal lines 287, 288 and 289 from cache control circuit 281.

CPU core 1 performs data transfer with cache entry table 8 through internal bus 285. Generally, data transfer between CPU 290 and external memory 283 is performed at a relatively slow speed. This is because of a large overhead in data transfer by way of external bus 286. When an overhead in data transfer is large, CPU 290 is required to defer processing until all necessary data are prepared.

In order to reduce an influence due to overhead in access to external memory 283, such as an increased processing time to cause degradation in system performance, data of external memory 283 is temporarily stored in cache entry table 8 within CPU 290. CPU core 1 and cache entry table 8 are interconnected through internal bus 285 constituted of in-chip interconnection lines and in addition, a cache memory is usually constituted of a high speed memory. Thus, data can be transferred at high speed between CPU core 1 and cache entry table 8. Therefore, in a case where data that CPU core 1 requires is stored in cache entry table 8, no necessity arises for access to external memory 283, thus enabling high speed processing.

In a configuration of the processing system shown in FIG. 29, a function of a cache memory is implemented by cache entry table 8 and cache control circuit 281. A storage capacity of cache entry table 8 is usually smaller, compared with a storage capacity of external memory 283. Generally, external memory 283 is constituted of DRAM (dynamic random access memory) having a low cost per bit, while cache entry table 8 is constituted of SRAM (static random access memory) or a content addressable memory (CAM), each having a relative high cost per bit. Therefore, in order to reduce a cost of and a chip area of CPU 290 to the minimum, a storage capacity of cache entry table 8 is made small.

By storing data high in frequency of accessing by CPU core 1, among data stored in external memory 283, in cache entry table 8 to reduce a frequency of access of CPU core 1 to external memory 283, processing of the system as a whole can be made faster.

FIG. 30 is a table showing a construction of cache entry table 8 shown in FIG. 29 schematically. In FIG. 30, cache entry table 8 includes a a plurality ofity of entries EN0 to ENn. Each of entries EN0 to ENn includes: a data hold section 317 storing corresponding data of external memory 283; a tag section 316 storing a tag address of data held in data hold section 317; and a hold bit section 315 storing a hold bit indicating whether or not valid data is stored in a corresponding data hold section 317. A tag address stored in tag section 316 is an address specifying an address region, in external memory 283, of data stored in data hold section 317.

Data hold section 317 is generally constituted of a a plurality ofity of words, with a bus width of internal bus 285 being one word. In a case where a bus width of external data bus 286 is narrower than the total number of bits of data words stored in data hold section 317, a a plurality ofity of runs of data transfer are performed on external memory 283 to store data of external memory 283 into data hold section 317 of cache entry table 8.

FIG. 31 is an illustration schematically showing a construction of an address outputted by CPU 1. In FIG. 31, a CPU address CPAD outputted by CPU core 1 includes an upper address UPAD and a lower address LWAD. Upper address UPAD corresponds to a tag address stored in cache entry table 8. Lower address LWAD includes: an entry address section 102 storing an entry address designating an entry stored in cache entry table 8; and an off-set address section 103 storing an offset address designating a word stored in an entry.

That is, a plurality of entries are present in an address region specified by upper address UPAD and an entry in the address region specified by upper address UPAD is designated by entry address section 102. Therefore, data having different entry addresses are stored in cache entry table 8. The number of entries EN0 to ENn provided in cache entry table 8 is the number of addresses that can be represented by the entry address in entry address section 102. For example, in a case where lower address LWAD is formed of 10 bits and each of entries EN0 to ENn includes 4 words, off-set address section 103 is constituted of 2 bits. Since entry address section 102 is constituted of 8 bits, the number of entries EN0 to ENn in cache entry table 8 amounts to 2^{8,} or 256.

FIG. 32 is an illustration showing a construction of an address of external memory 283. One of address blocks UPAD0 to UPADs in external memory 283 is specified by upper address UPAD of CPU address CPAD. In other words, one of address blocks UPAD0 to UPADs is specified by a tag address stored in tag section 316. Each of address blocks UPAD0 to UPADs includes a plurality of entries EN0 to ENn. One of entries EN0 to ENn is specified by an entry address.

Each of entries EN0 to ENn includes a plurality of words WD0 to WDk. One of words WD0 to WDk is specified by an off-set address.

Therefore, when CPU core 1 outputs a normal CPU address CPAD specifying a word of external memory 283, cache control circuit 281 shown in FIG. 29 determines whether or not addressed data is stored in cache entry table 8. If data requested for addressing is stored in cache entry table 8, it is determined as “cache hit”, and an access is made to cache entry table 8. On the other hand, if no data requested for accessing exists in cache entry table 8, it is determined as “cache miss”, and access is made to external memory 283.

That is, cache control circuit 281 reads out a corresponding entry of cache entry table 8 according to an entry address of entry address section 102 of CPU address CPAD, compares a tag address of tag section 316 of the read entry with a CPU upper address, and makes a determinationon-cache hit/cache miss according to coincidence/non-coincidence between the compared addresses.

Here, in the determination, it is required that the stored data is indicated to be valid by a hold bit stored in hold bit section 315. A hold bit stored in hold bit section 315 indicates that valid data is stored in a corresponding entry.

FIG. 33 is a diagram schematically showing a configuration of cache control circuit 281 shown in FIG. 29. In FIG. 33, a construction of cache entry table 8 is shown together. To cache entry table 8, lower address LWAD is applied from CPU core 1 through address buses 305 and 307. Cache entry table 8 outputs a tag address stored in tag section 316 of a corresponding entry onto tag address bus 309 and a signal line 318 together with a hold bit in a corresponding hold bit section 315 according to an entry address included in lower address LWAD.

Cache control circuit 281 includes: a cache control register 2 storing an on/off bit designating caching/non-caching of data applied from CPU core 1: a comparison circuit 301 comparing upper address UPAD applied through address buses 305 and 306 from CPU core 1 with a tag address read from cache entry table 8; a NAND circuit 302 receiving a hold bit read out onto signal line 318 from cache entry table 8 and an output signal of comparison circuit 301; an AND circuit 303 receiving an output signal of comparison circuit 301 and a hold bit on signal line 318; an AND circuit 310 receiving an on/off bit applied through signal line 308 from cache control register 2 and an output signal of NAND circuit 303; an AND circuit 311 receiving on/off bit from the cache control register 2 on signal line 308 and an output signal of NAND circuit 302; and cache update execution circuit 300 receiving a write access instructing signal WR applied from CPU core 1 through signal line 319 and output signals of AND circuits 310 and 311 to update contents of cache entry table 8.

Cache update execution circuit 300 updates data/bits stored in hold bit section 315, tag section 316 and data hold section 317 of a corresponding entry through signal lines 321, 322 and 323 upon write access to perform data write. Then description will now be given of operation in the cache control circuit shown in FIG. 33.

Now, when CPU core 1 reads data at a given address, an address indicating an address where data to be accessed is stored is transmitted onto address bus 305. Lower address LWAD of the address outputted from CPU core 1 onto address bus 305 is applied to cache entry table 8 through lower address bus 307. Read out from cache entry table 8 are a hold bit stored in hold bit section 315 and a tag address stored in tag section 316 of an entry designated by the entry address included in the lower address LWAD.

Through a path not shown, data stored in corresponding data hold section 317, at this time, is read out and the data (a word) stored in data hold section 317 is selected according to lower off-set address. No transfer of a selected word is performed till a result of cache hit/miss is decided. Transfer of the selected data (a word) is selectively performed according to the result of cache hit/miss determination.

In a case where no valid data is registered in a selected entry yet, since a hold bit stored in hold bit section 315 is not set yet, a signal at L level is outputted onto signal line 318. Therefore, NAND circuit 302 outputs a signal at H level, while AND circuit 303 outputs a signal at L level.

When CPU core 1 set on/off bit of cache control register 2 to an on state in order to designate caching of data, a signal on signal line 308 attains H level and an output signal MIS of AND circuit 311 attains H level. It is assumed that in this situation, cache update execution circuit 300 is configured to update the cache regardless of a write/read mode of data when output signal MIS of AND circuit 311 is at H level.

When contents of cache entry table 8 is updated, cache update execution circuit 300 sets a hold bit of hold bit section 315 of a selected entry through signal 321. Furthermore, data read out from external memory 283 is stored into data hold section 317 of the selected entry through signal line 323 and a corresponding tag address into tag section 316 of the selected entry.

In FIG. 33, there is not explicitly shown a configuration of a part for reading out data from external memory 283. Read of data from external memory is executed by bus control circuit 282 (see FIG. 29).

When valid data is already stored in the selected entry, a hold bit of hold bit section 315 is already set at H level. In a case where a tag address read out from tag section 316 of the selected entry through tag address bus 309 coincides with CPU upper address UPAD on upper address bus 306, an output signal of comparison circuit 301 attains H level. Furthermore, since a corresponding hold bit is set to H level, a signal on signal line 318 is driven to H level, an output signal of NAND circuit 302 goes to L level and an output signal of AND circuit 303 goes to H level.

In this situation, output signal HIT of AND circuit 311 is at H level and output signal MIS of AND circuit 311 at L level. Therefore, cache update execution circuit 300 executes no updating of contents of the selected entry of cache entry table 8. The selected entry of cache entry table 8 holds intactly.

That is, when output signal HIT of AND circuit 310 is at H level and output signal MIS of AND circuit 311 is at L level, data requested of accessing by CPU core 1 is stored in cache entry table 8.

On the other hand, when upper address UPAD transmitted onto address bus 306 through address bus 305 from CPU core 1 non-coincides with a tag address stored in tag section 316 read out from cache entry table 8, an output signal from comparison circuit 301 is driven to L level, an output signal of NAND circuit 302 to H level and an output signal of AND circuit 310 to L level.

In this case, signal HIT attains L level and signal MIS attains H level, and accordingly cache update execution circuit 300 execute updating of contents of a selected entry in a way similar to the operation when a hold bit of hold bit section 315 is in a reset state.

A case where upper address UPAD coincides with a tag address to allow an access to cache entry table 8 without updating contents of a corresponding entry of cache entry table 8 is referred to as “cache hit”. In cache hit, there is no need to read data from external memory 283, and CPU core 1 has only to refer to data held in cache entry table 8, resulting in a reduced time required for data read by CPU core 1. The cache hit is indicated by an output signal HIT of AND circuit 301 being at H level.

On the other hand, a case where upper address UPAD non-coincides with a tag address read out onto tag address bus 309 and the contents of the cache is updated for data read, is referred to “cache miss.” In cache miss, it takes a longer time for data read, compared with a case of cache hit since requested data is read from external memory 283. The cache miss is indicated by an output signal MIS of AND circuit 311 being at H level.

Therefore, in a case where CPU core 1 performs data read, access to and updating of contents of cache entry table 8 are selectively effected according to output signal HIT of AND circuit 310 and output signal MIS of AND circuit 311. Now, a description will be briefly given of operation in CPU core 1 in a data write operation.

As a scheme for writing data to a cache memory (a cache entry table), there are generally schemes referred to as the write-through scheme and the copy-back scheme. In the write-through scheme, upon cache hit, data writing is performed both to cache entry table 8 and external memory 283. In the copy-back scheme, upon cache hit, data writing only to cache entry table 8 is performed. Data writing to external memory 283 is executed upon updating of data in a corresponding entry. That is, in the copy-back scheme, no data write to external memory 283 is performed till cache miss occurs in data write.

As control in write cache miss, two schemes are generally employed: a scheme referred to as the fetch-on-write scheme or the write-allocate scheme, in which write data is overwritten on a corresponding entry after updating of cache entry table 8; and the other in which upon write cache miss, only data write to an a corresponding address of external memory 283 is performed without performing data write to cache entry table 8, and updating of contents of cache entry table 8 is not performed.

In the configuration of cache control circuit 281 shown in FIG. 33, when output signal HIT of AND circuit 310 is at H level, and a write access instructing signal outputted from CPU core 1 through signal line 319 is at H level, cache update execution circuit 300 overwrites write data outputted from CPU core 1 on data (word) stored in data hold section 317 of a corresponding entry of cache entry table 8. At this time, data write is performed to external memory 283 as well by bus control circuit 282 (see FIG. 29) upon cache hit. That is, upon cache hit, data write is performed according to the write-through scheme.

Moreover, when a write access instructing signal applied from CPU core 1 through signal line 319 is at H level to indicate data write, and output signal MIS of AND circuit 311 is at H level, cache update execution circuit 300 writes the data, updated by write data of external memory 283 applied from bus control circuit 282 shown in FIG. 29, to a corresponding data holding section 317 of cache entry table 8 to update the contents therein.

Therefore, in cache controller 281, as a write scheme, the write-through scheme and the write-allocate scheme are employed.

In a general cache controller, as a control scheme in data write, the following is generally employed: one of the write-through scheme and the copy-back scheme upon cache hit; and one of the write-allocate scheme and the non-write-allocate scheme (non-update scheme) upon cache miss.

A write scheme cannot be selected for each of access regions, but write access is performed in all cache regions according to a selected write scheme.

In order to improve a system performance to achieve a high speed processing, necessity arises that stored data in external memory 283 is properly selected to store data with a high frequency of access by CPU core 1 into a cache memory (cache entry table 8). This is for reducing the number of times of access to external memory 283. Data stored in cache entry table 8 is data in an address region designated as a cache region on the system. It is set by an on/off bit stored into cache control register 2 from CPU core 1 whether or not the access region is a cache region. That is, when output signals HIT and MIS of respective AND circuits 310 and 311 are both at L level, it is designated to access data in a non-cache region.

In order to speed up the data transfer between CPU core 1 and cache entry table 8, it is required to restrict processing required for data transfer to the minimum. Hence, in a system using a conventional cache controller, especially in a high speed and high performance system, a cache object region is, in many cases, fixed in an address space defined on the system. Therefore, in a system using a conventional cache controller, data are required to be arranged with a cache object region taken into account, and a cache object region optimal for an application of a system using the cache controller cannot be set, leading to a problem of lack of versatility of the system in the entirety.

FIG. 34 is an illustration showing an example of an address space on a system. In FIG. 34, in an address space on the system, a region ADR1 of an address H0000_{—}0000 to an address H7FFF_FFFF is used as a cache object region and a region ADR2 of an address H8000_{—}0000 to an address HFFFF_FFFF is used as a non-cache object region.

In a system for which an address space is defined as shown in FIG. 34, data that is not desired to be stored in cache entry table 8 has to be stored in the address region ADR2. In order to discriminate address object region ADR1 from address object region ADR2, the most significant byte (4 bits) addresses are different from each other. Therefore, in a case where such an address space is defined, for data access to address region ADR2, an address of 8 bytes, that is 32 bits is necessary for an address designation, resulting in a problem of increasing a size of a program code.

That is, in a case where an address space of a cache object region is fixed, a region usable as a connection destination of an external I/O device and a DMA transfer region is limited to address region ADR2 external to a cache object region, which makes it difficult to assign an address region flexibly depending on an application of the system, leading to a problem of lack of versatility of the system as a whole.

Moreover, in a case where an address region necessary for a system is a region of an address H000_{—}0000 to an address HFFF_FFFF, problems occur that the number of address bits increases, to increase a size of a program code, and to further increase a storage capacity of a program memory, if address regions ADR1 and ADR2 of the same address space size are provided separately in order to facilitate address control on the cache object region and the non-cache object region.

### SUMMARY OF THE INVENTION

It is an object of the present invention to provide a cache controller capable of achieving a system high in versatility without degradation in high speed operability.

It is another object of the present invention to provide a cache memory controller capable of changing assignment of an address region with ease and furthermore, capable of readily changing a data write scheme in a cache region according to an address region.

A cache memory controller according to a first aspect of the present invention is a cache memory control circuit for controlling access to a cache memory serving for access to a prescribed address space, and includes: a region designation register for storing region designating data designating an address region in the prescribed address space; a valid bit register for storing a region designation validating bit indicating whether or not a designation of the address region designated by the region designating data is valid; a region determination circuit for determining whether or not a region requested of access is a region designated by the region designating data according to a applied address and the region designating data; and a control circuit for controlling an access to the cache memory according to a result of determination by the region determination circuit and the region designation validating bit.

A cache memory controller according to a second aspect of the present invention includes: a DMA control circuit for performing an access to an external memory, and including (1) a source address storage register for storing a source address designating a data transfer source address, (2) a destination address register for storing a transfer destination address designating a transfer destination of data, (3) and a data size register for storing data size designating data designating a size of transfer data; a bus control circuit for controlling an operation for transferring data through an external bus according to a DMA transfer request; a region designating data register for storing a region designating data indicating whether or not a specific address region in a system address space is used as a cache region; a transfer control circuit for performing invalidation of cache in an address region at the designated transfer destination when a DMA transfer request is generated and a data transfer destination region is contained in an address region designated by the region designating data according to stored data of the transfer destination register and the transfer data size designating data.

According to region designating data stored in the region designating data register, a desired address region in the system address space can be used as either a cache region or non-cache region, to thereby enable assignment of a cache region in the system address space with flexibility to allow setting of an address space of the system with flexibility depending on an application.

Moreover, by designating a write scheme according to the region designating data, a data write scheme for a desired address region in a cache region can be set to enable setting of a write scheme with flexibility according to contents of processing or a system architecture.

Furthermore, by performing invalidation of a cache in units of entries, a caching of data in a desired region can be invalidated without invalidation of a entire cache, thereby improving high speed processing performance.

In addition, in DMA transfer as well, a corresponding transfer destination region can be selectively used as a cache region or a non-cache region to enable setting of a transfer destination address region in the DMA transfer with flexibility, thereby allowing a construction of address regions of the system to be set according to an application with flexibility. Moreover, when an address of a transfer destination is a designated address region, invalidation of a cache is automatically performed in the cache memory controller, thereby allowing integrity of data to be maintained.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a diagram schematically showing a configuration of a cache controller according to a first embodiment of the present invention;

FIG. 2 is an illustration showing an example of a construction of an address region in the cache controller shown in FIG. 1;

FIG. 3 is a diagram schematically showing a configuration of a non-cache region determination circuit shown in FIG. 1;

FIG. 4 is a diagram schematically showing a configuration related to one bit of the non-cache region determination circuit shown in FIG. 3;

FIG. 5 is an illustration showing an example of a construction of mask bits of a mask circuit of the non-cache region determination circuit shown in FIG. 3;

FIG. 6 is a diagram showing a modification of the non-cache region determination circuit shown in FIG. 1;

FIG. 7 is a diagram showing still another configuration of the non-cache region determination circuit shown in FIG. 1;

FIG. 8 is a diagram schematically showing a main portion of a cache controller of a modification of the first embodiment according to the present invention;

FIG. 9 is a diagram schematically showing an overall configuration of a cache controller according to a second embodiment of the present invention;

FIG. 10 is a flow chart representing an operation of the cache controller shown in FIG. 9 upon data reading;

FIG. 11 is a flow chart representing an operation of the cache controller shown in FIG. 9 upon data writing;

FIG. 12 is a flow chart representing an operation of the cache controller shown in FIG. 9 in data writing;

FIGS. 13A and 13B are flow charts representing operations of the cache controller shown in FIG. 9 in data writing;

FIG. 14 is a flow chart showing an operation of the cache controller shown in FIG. 9 in data writing;

FIG. 15 is an illustration showing assignment of address regions of the cache controller shown in FIG. 9 schematically;

FIG. 16 is a diagram showing a configuration of a cache controller according to a third embodiment of the present invention;

FIG. 17 is an illustration showing an example of a construction of an address region of the cache controller shown in FIG. 16;

FIG. 18 is an illustration showing a construction of a non-cache region setting register of a modification of the third embodiment of the present invention schematically;

FIG. 19 is a diagram schematically showing a configuration of a cache controller according to a fourth embodiment of the present invention;

FIG. 20 is an illustration showing an example of the sequence of word updating in an entry of the cache controller shown in FIG. 19;

FIG. 21 is a diagram schematically showing a configuration of a main portion of a cache update execution circuit shown in FIG. 19;

FIG. 22 is an illustration showing a construction of an address region of the cache controller shown in FIG. 19 schematically;

FIG. 23 is a diagram schematically showing a configuration of a bus interface section of a cache controller in the fourth embodiment according to the present invention;

FIG. 24 is a diagram schematically showing an overall configuration of a cache controller according to a fifth embodiment of the present invention;

FIG. 25 is a flow chart representing an operation of the cache controller shown in FIG. 24;

FIG. 26 is a diagram schematically showing a configuration of a system according to a sixth embodiment of the present invention;

FIG. 27 is an illustration showing a construction of an address region of the system shown in FIG. 26 schematically;

FIG. 28 is a diagram showing an example of a configuration of an inclusion detection circuit shown in FIG. 26;

FIG. 29 is a diagram showing an example of a configuration of a conventional microprocessor system;

FIG. 30 is a table showing a construction of a cache entry table shown in FIG. 29 schematically;

FIG. 31 is an illustration showing a construction of a CPU address of the processing system shown in FIG. 29 schematically;

FIG. 32 is an illustration showing a construction of stored data in a cache entry table shown in FIG. 29 schematically;

FIG. 33 is a diagram schematically showing a configuration of a conventional cache controller; and

FIG. 34 is an illustration showing a construction of an address region of a conventional microprocessor system schematically.

### DESCRIPTION OF THE PREFERRED EMBODIMENTS

First Embodiment

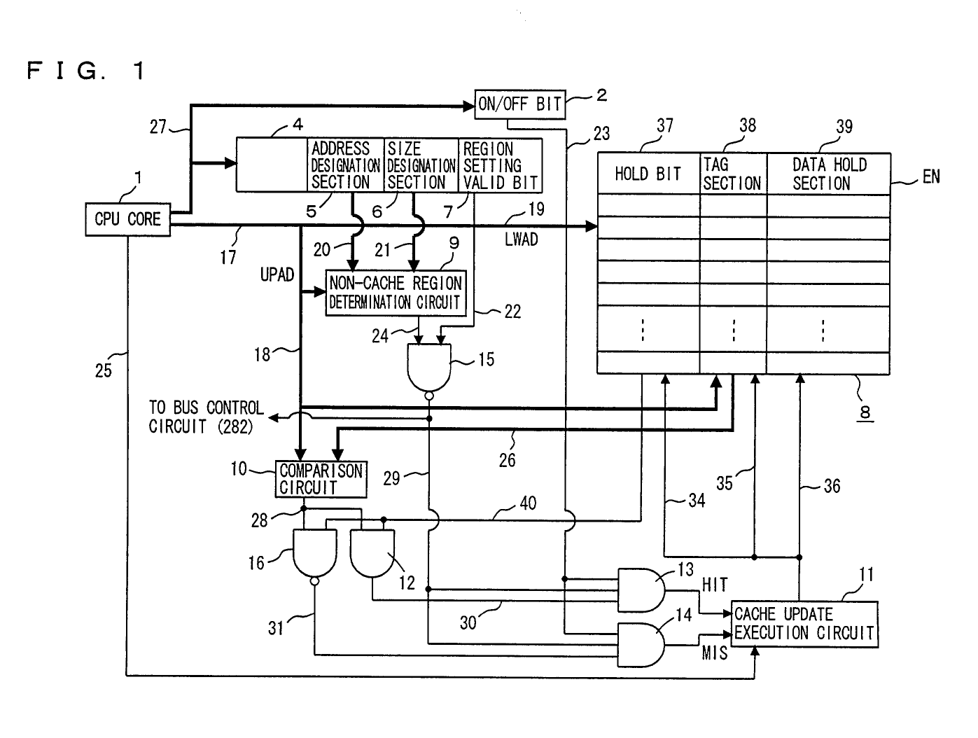

FIG. 1 is a diagram schematically showing an overall configuration of a cache controller according to a first embodiment of the present invention. The cache controller shown in FIG. 1 is applied to the processing system shown in FIG. 29 as a CPU system. That is, in FIG. 1, there is shown a configuration corresponding to cache control circuit 281 and cache entry table 8 shown in FIG. 29.

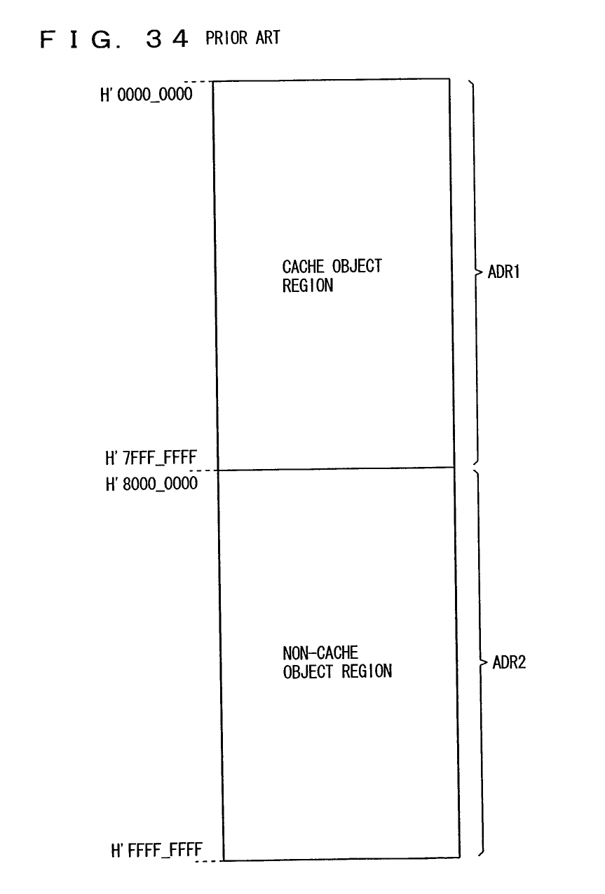

Furthermore, as a system address space, an address space shown in FIG. 34 is defined. In FIG. 1, the cache controller includes: a non-cache region setting register 4 for storing non-cache region setting data applied from CPU core 1 through a data bus 27; and a non-cache region determination circuit 9 for determining whether or not a region requested of access is set to a non-cache region according to data stored in non-cache region setting register 4 and upper address UPAD applied from CPU core 1 onto an upper address bus 18.

Non-cache region setting register 4 includes: an address designation section 5 for storing a start address of an address region set as a non-cache region; a size designation section 6 for storing size data designating a size of the non-cache region; and a region setting valid bit section 7 for storing a region setting valid bit indicating whether or not a set value in non-cache region setting register 4 is valid.

Of an address space defined on the system, a region with a size of address space designated by size designation section 6, starting at a start address designated by address designation section 5, is selectively used as a non-cache region. As a non-cache region set in the non-cache region setting register 4, an address region in the cache object region shown in FIG. 34 is designated.

Non-cache region determination circuit 9 identifies a non-cache region according to a start address applied from address designation section 5 of non-cache region setting register 4 through a signal line 20 and region size information applied from size designation section 6 through a signal line 21, and determines whether or not an address designated by upper address UPAD applied from CPU core 1 through address bus 18 is included in a non-cache region set by non-cache region setting register 4.

Non-cache region determination circuit 9 outputs a signal at H level when upper address UPAD applied onto upper address bus 18 from CPU core 1 is included in a non-cache region set in non-cache region setting register 4.

The cache controller further includes: a NAND circuit 15 receiving a determination result signal applied onto a signal line 24 from non-cache region determination circuit 9 and a region setting valid data applied from non-cache region setting register 4 through signal line 22; a comparison circuit 10 for comparing a tag address applied from an entry selected according to CPU lower address LWAD in cache entry table 8 through a tag address bus 26 with upper address UPAD on upper address bus 18; an AND circuit 12 receiving a comparison result signal applied onto signal line 28 from comparison circuit 10 and a hold bit from hold bit section 37 of a selected entry read out from cache entry table 8; a cache control register 2 storing an on/off bit designating a cache mode applied from CPU core 1 through bus 27; a NAND circuit 13 receiving an on./off bit from cache control register 2, a signal from NAND circuit 16 and a signal applied from NAND circuit 15 through signal line 29; an AND circuit 14 receiving a signal applied onto a signal line 31 from AND circuit 12, an output signal of NAND circuit 15 and an on/off bit from cache control register 2 applied through signal line 23; and a cache update execution circuit 11 receiving output signal HIT of AND circuit 13, output signal MIS of AND circuit 14 and a write access instructing signal from CPU core 1 to update contents of the cache entry table. A write access instructing signal is applied to cache update execution circuit 11 from CPU core 1 through signal line 25.

Cache entry table 8 includes a plurality of entries EN. Each of entries EN includes a data hold section 39 for storing corresponding data of an external memory; a tag section 38 for storing a tag address of data stored in data hold section 39; and a hold bit section 37 for storing a hold bit indicating whether or not valid data is stored in associated data hold section 39.

Lower address LWAD is applied to cache entry table 8 from CPU core 1 through address bus 17 and lower address bus 19. In cache entry table 8, a corresponding entry is selected according to an entry address included in lower address LWAD in a manner similar to a conventional system, and a tag address of tag section 38 of the selected entry is read onto tag address bus 26.

Cache update execution circuit 11 controls updating of stored data in hold bit section 37, tag section 38 and data hold section 39 of cache entry table 8 through signal lines 34, 35 and 36. Now, description will be given of operation of the cache controller shown in FIG. 1.

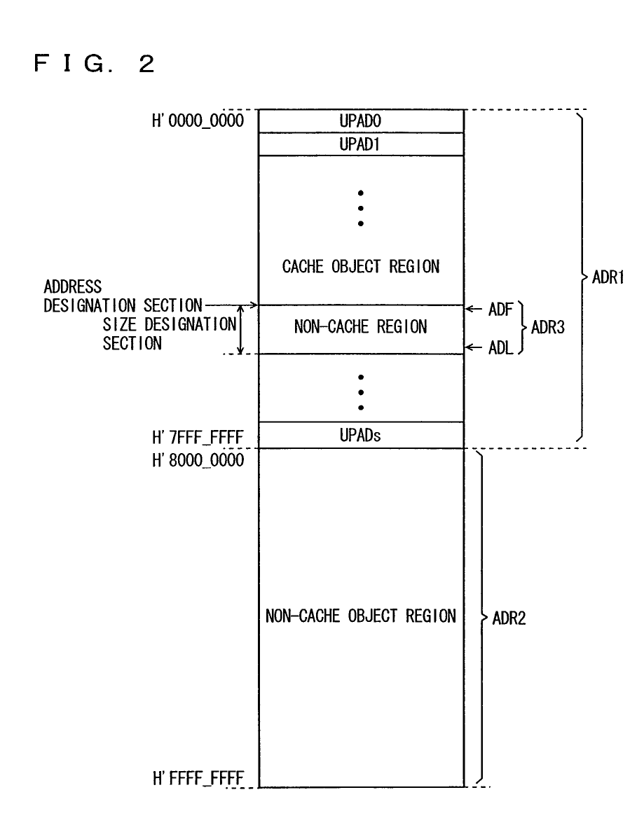

Now, as shown in FIG. 2, for the address space on the system, address regions ADR1 and ADR2 are set as a cache object region and a non-cache object region, respectively. In this situation, in address region ADR1, which is a cache object region, a start address ADF is set in address designation section 5 of non-cache setting register 4, and a size of an address region of a non-cache address region starting at the start address is set by size designation section 6.

Therefore, by addition of a size designated by size designation section 6 to start address ADF designated by address designation section 5, a last address ADL of the non-cache region is obtained.

Setting of the non-cache region may be performed with any size of an address region being a unit, as will be described later. Here, for simplification of description, in address designation section 5, designation of an address of a non-cache region is performed with a data address block designated by upper address UPAD being a unit. That is, in address region ADR1, there exists address block regions designated by respective upper addresses UPAD0 to UPADs and setting of a non-cache region is performed with an address block being a unit.

An address outputted from CPU core 1 includes upper address UPAD and lower address LWAD in a manner similar to the conventional system. Lower address LWAD includes an entry address designating an entry in cache entry table 8, and an offset address designating a word in the entry.

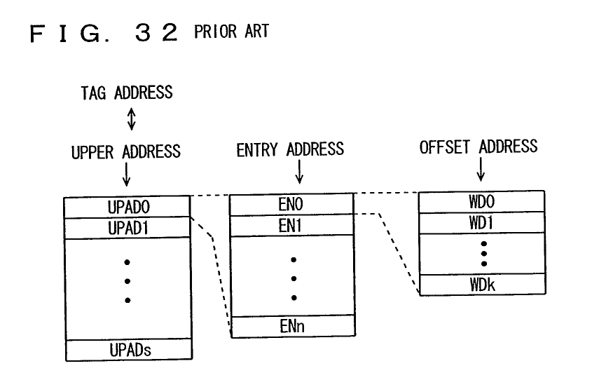

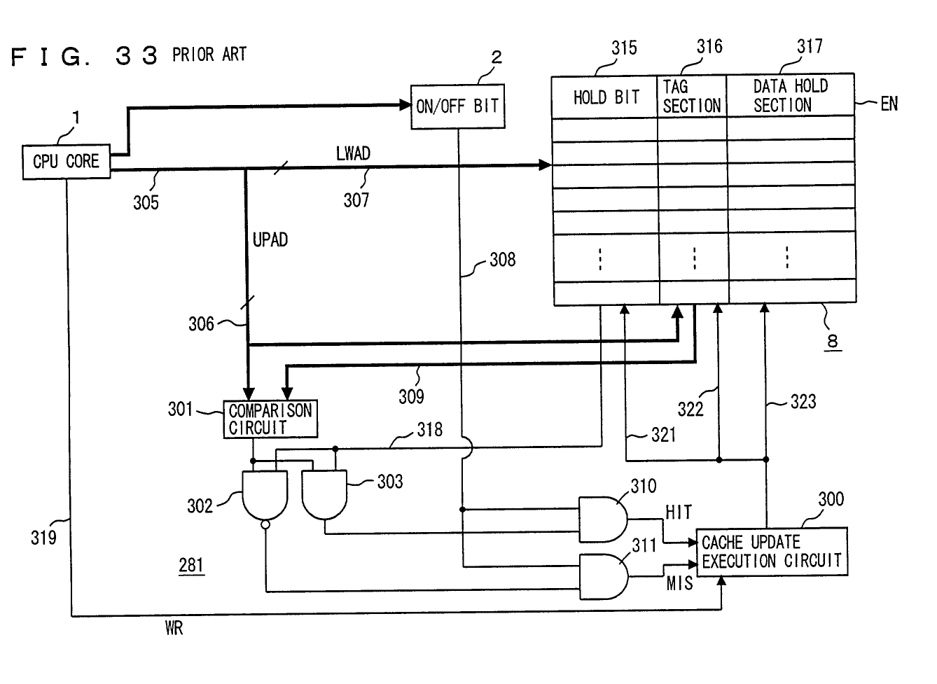

The number of entries EN prepared in cache entry table 8 is a number expressed by the number of bits of an entry address. If an entry address is of 8 bits, the number of entries is 256. In tag section 38 of cache entry table 8, an upper address of an address, at which data held currently in data hold section 37 is originally stored in an external memory, is stored as a tag address. The construction of cache entry table 8 is the same as that of the cache entry table shown in FIG. 30 and a correspondence between addresses is the same as in address assignment shown in FIGS. 32 and 33.

Moreover, in region setting valid bit section 7 of non-cache region setting register 4, a region setting valid data is set to valid state. In addition, read data of start address ADF of a non-cache region and a size of the non-cache region are stored in address designation section 5 and size designation section 6, respectively. Contents of non-cache region setting register 4 can be rewritten in a manner similar to an on/off bit included cache control register 3. That is, a non-cache region can be desirably set according to a program under execution and furthermore, a cache mode can be set to on/off state according to an on/off bit. Data caching is performed when cache mode is set on, while when the cache mode is set off, data transfer between external memory and CPU core 1 is performed without referring to cache entry table 8.

Access to a non-cache object region, which is address region ADR2 shown in FIG. 2, and access when an on/off bit included in cache control register 2 is set in cache-off mode are controlled by bus control circuit (282). That is, in access in non-cache mode and in access to non-cache object region ADR2, data transfer between CPU core 1 and external memory (see FIG. 29) are performed under control of bus control circuit (282).

Description will be given below of operation in a case where an on/off bit of cache control register 2 is set on to designate the cache mode and furthermore address region ADR1 is set as a cash object region. In a case when the entirety of address region ADR1 is used as a cache object region, a region setting valid bit is set in reset state (at L level) in region setting valid bit section 7 of non-cache region setting register 4. In this state, an output signal of NAND circuit 15 is fixed at H level. Hence, in this condition, states of output signals HIT and MIS of respective AND circuits 13 and 14 are determined according to coincidence/non-coincidence between a tag address read out from cache entry table 8 and upper address UPAD from CPU core 1. Cache update execution circuit 11 executes updating of contents of cache entry table 8 according to output signals HIT and MIS of respective AND circuits 13 and 14, and a write access instructing signal applied from CPU core 1 through signal line 25.

Now, consider a case where when a region designation bit stored in region setting valid bit section 7 of non-cache region setting register 4 is set into valid state, a signal at H level is outputted onto signal line 22. Data indicating start address ADF and a size of the non-cache region are stored in address designation section 4 and size designation section 6 of non-cache region setting register 4, respectively.

Non-cache region determination circuit 9 determines whether or not an address designated by upper address UPAD from CPU core 1 is included in a non-cache region. If upper address UPAD is included in the non-cache region, cache region determination circuit 9 outputs a signal at H level. Responsively, NAND circuit 15 outputs a signal at L level since a signal at H level is transmitted through signal lines 22 and 24. Therefore, in this state, output signals HIT and MIS of respective AND circuits 13 and 14 are both driven to L level and cache entry update execution circuit 11 determines that a non-cache object region is designated and does not update cache entry table 8. Furthermore, no data reading from cache entry table 8 is performed either.

On the other hand, when a signal on output signal line 29 of NAND circuit 15 is driven to L level, bus control circuit (282) is activated to execute access to external memory. That is, except that no updating of cache entry table 8 is performed, there is performed an operation equivalent to operation upon cache miss of the conventional cache controller.

On the other hand, when CPU core 1 makes an access to a region other than non-cache region ADR3 of cache object region ADR1, an output signal of non-cache region determination circuit 9 assumes L level to cause an output signal of NAND circuit 15 assumes H level. Hence, at this time, logic levels of output signals HIT and MIS of AND circuits 13 and 14 are decided according to coincidence/non-coincidence between a tag address read out from cache entry table 8 and upper address UPAD, and a hold bit stored in hold bit section 37.

When a hold bit stored in hold bit section 37 is at H level of the valid state, one of output HIT of AND circuit 13 indicating cache hit and output signal MIS of AND circuit 14 indicating cache miss is driven to H level. Cache update execution circuit 11 executes a necessary operation control according to the signals HIT and MIS.

When a hold bit is set at L level of the invalid state, no valid data is stored in cache entry table 8, and therefore, the signal HIT attains L level, while the signal MIS attains H level, and an operation in cache miss is performed to update cache entry table 8.

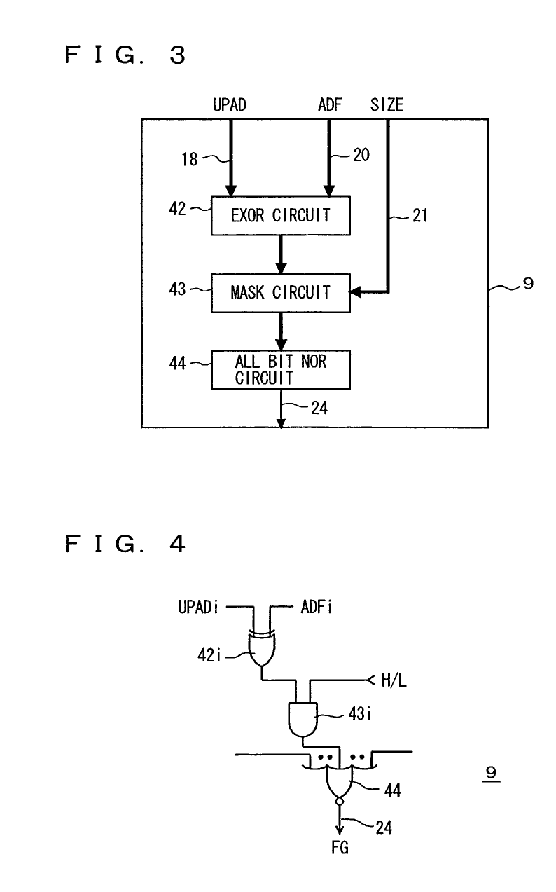

FIG. 3 is a diagram showing an example of a configuration of non-cache region determination circuit 9 shown in FIG. 1. In FIG. 3, non-cache region determination circuit 9 includes: an EXOR circuit 42 detecting coincidence/non-coincidence in respective bits between upper address UPAD applied onto upper address bus 18 from CPU core 1 and start address ADF applied from address designation section 5 of non-cache region setting register 4 through bus 20; a mask circuit 43 receiving size data SIZE stored in size designation section 6 through signal line 29 to mask an output signal of EXOR circuit 42 by the number of bits designated by the size data SIZE; and an all bit NOR circuit 44 performing a NOR operation on all output signals from mask circuit 43.

Mask circuit 43 masks the output signals of EXOR circuit 42 by a necessary bit width according to an address region size indicated by size data SIZE applied from size designation section 6. For example, in a case where an address block designated by upper address UPAD has a storage capacity of 4 K bytes and if size data SIZE designates a region of 8 K bytes, mask circuit 43 masks the output signal corresponding to a lower 2 bit address out of output signals of EXOR circuit 42, to output a signal at L level for each of the masked bits.

When logic levels of corresponding bits of upper address UPAD and start address ADF coincide with each other, EXOR circuit 42 outputs a signal at L level. Hence, when outputs signals of mask circuit 42 are all at L level, all bit NOR circuit 44 outputs a signal at H level onto signal line 24 to indicate that a non-cache region is addressed.

FIG. 4 is a diagram showing a detailed configuration of non-cache region determination circuit 9 shown in FIG. 3. In FIG. 4, there is shown a configuration of a section related to upper address bit UPADi and start address bit ADFi. In FIG. 4, EXOR circuit 42 includes an EXOR gate 42i receiving upper address bit UPADi and start address bit ADFi. EXOR gate 42i is provided corresponding to each pair of bits of upper address UPAD and start address ADF.

Mask circuit 43 includes an AND gate 43i receiving an output signal of EXOR gate 42i and a mask signal H/L. Mask signal H/L is generated, for example, by decoding the size data SIZE. For example, when the minimum unit of an address block is of 4 K bytes and a size of a set non-cache region is of 8 k bytes, mask signals M/L for a lower 2 bit address are set to L level. When mask signal H/L is set to H level, an output signal of corresponding EXOR gate 42a is valid. When mask signal H/L is set to L level, an output signal of AND gate 43i is set to L level to mask an output signal of EXOR circuit 42i.

All bit NOR circuit 24 receives all output signals of AND gates 43i provided corresponding to the respective outputs of mask circuit 43.

When upper address UPAD is included in an address region designated by start address ADF and size data SIZE, EXOR gates 42i provided at digits higher than a region designated by mask signal H/L are all driven to L level. On the other hand, when an upper address is present outside the non-cache region, an upper address has at least one bit non-coincide with a start address. At least one bit of the outputs of EXOR gates provided at digits higher than a mask data bit set in a valid state attains a signal at H level.

When an output signal of AND gate 43i is at L level, it indicates coincidence between corresponding address bits. Therefore, when address bits upper than a region masked by mask signal H/L are all in coincidence, output signal FG of all bit NOR circuit 44 attains H level.

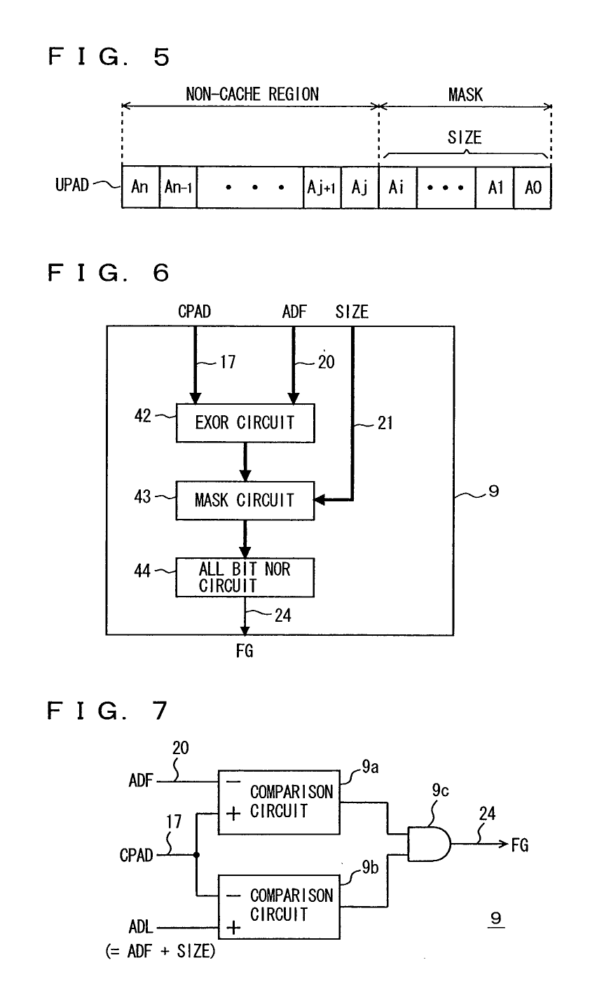

That is, as shown in FIG. 5, in upper address UPAD of a CPU address, when, of address bits A<n:0>, a size of a non-cache region is designated by lower address bits A<i:0> and the rest of upper address bits A<n:j> coincide with start address ADF of the non-cache region, an output signal of all bit NOR circuit 44 attains to H level since address bits A<i; 0> are masked. Hence, an address region of a block of a region starting at a start address of an address (An, . . . , Aj, 0, . . . , 0) and ending at an address (An, Aj, 1, . . . , 1) can be used as a non-cache region.

First Modification

FIG. 6 is a diagram showing a modification of non-cache region determination circuit 9 of the first embodiment of the present invention. In FIG. 6, a prescribed number of address bits are applied to EXOR circuit 42 from CPU core 1 through address bus 17. Therefore, in this case, CPU address CPAD (including upper address UPAD and lower address LWAD) is used as substitution for upper address UPAD shown in FIG. 5. A prescribed number of lower bits are masked according to size data SIZE.

A possible configuration for generating mask signal H/L according to size data SIZE may be such that size designation section 6 is configured to store data indicating valid/invalid state for each of address bits. In this configuration, size data SIZE has the same bit width as CPU address CPAD.

Furthermore, alternatively, a configuration may also be employed, in which size data SIZE is decoded to generate mask signal H/L for each of address bits. For such a decode circuit, a decode circuit using ROM (read only memory) can be used. In this case, a bit width of size data SIZE can be reduced according to a size of an implementable non-cache region.

Second Modification

FIG. 7 is a diagram showing a configuration of non-cache region determination circuit 9 according to a second modification of the first embodiment of the present invention. In FIG. 7, non-cache region determination circuit 9 includes: a comparison circuit 9a for comparing CPU address CPAD with start address ADF stored in address designation section 5; a comparison circuit 9b for comparing CPU address CPAD with last address ADL; and an AND circuit 9c receiving output signals of comparison circuits 9a and 9b to generate a determination result signal FG onto signal line 24. Last address ADL is an address obtained by adding start address ADF to an address region size designated by size data SIZE and indicates the last address of a non-cache region.

Comparison circuit 9a outputs a signal at H level when CDU address CPAD is equal to or greater than start address ADF. On the other hand, comparison circuit 9b outputs a signal at H level when CPU address CPAD is equal to or smaller than last address ADL. Therefore, when CPU address CPAD designates an address of start address ADF or grater and an address of last address ADL or smaller, AND circuit 9c raises the signal FG on signal line 24 to H level to indicate that a non-cache region is addressed.

On the other hand, when CPU address CPAD is outside a set non-cache region, one of output signals of comparison circuits 9a and 9b attains L level to drive the signal FG on signal line 24 to L level.

Last address ADL is obtained by adding start address ADF to an address region value indicated by size data SIZE. Therefore, in a case of the configuration of non-cache region determination circuit 9 shown in FIG. 7, any address can be set as start address ADF to allow an address region starting at any address to be used as a non-cache region.

Third Modification

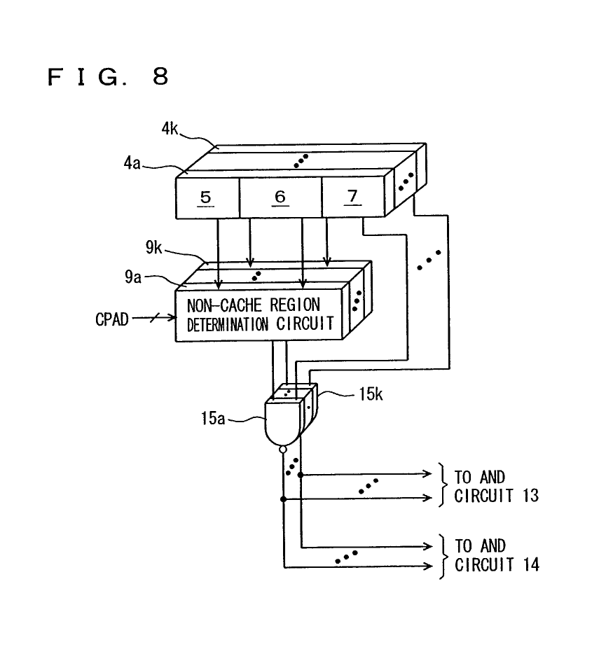

FIG. 8 is a diagram schematically showing a construction of a main portion of a cache controller of a third modification of the first embodiment of the present invention. In FIG. 8, the cache controller includes non-cache region setting registers 4a to 4k provided in parallel, and non-cache region determination circuits 9a to 9k provided corresponding to the respective non-cache region setting registers 4a to 4k.

Non-cache region setting registers 4a to 4k all have the same configuration and each includes address designation section 5, size designation section 6 and region setting valid bit section 7.

Each of non-cache region determination circuits 9a to 9k receives a start address stored in address designation section 5 and size data stored in size designation section 6 of corresponding non-cache region setting register 4a to 4k, and determines whether or not CPU address CPAD is included in a non-cache region set by corresponding non-cache region setting register 4a to 4k.

NAND gates 15a to 15k are provided corresponding to respective non-cache region determination circuits 9a to 9k. Each of NAND gates 15a to 15k receives an output signal of corresponding non-cache region determination circuit 9a to 9k and a valid bit stored in region setting enabling bit section 7 of corresponding non-cache region setting register 4a to 4k to output a signal indicating whether or not a non-cache region is addressed. Output signals of NAND gates 15a to 15k are applied in parallel to each of AND circuits 13 and 14 shown in FIG. 1.

In a case of the configuration shown in FIG. 8, a plurality of non-cache regions can be set and therefore, a cache/non-cache region can be set according to an application with more flexibility.

Moreover, by employing a configuration in which if size data (SIZE) of a non-cache region is set “0,” setting of the non-cache region is determined to be invalid, region setting valid bit section 7 can be omitted. That is, a configuration is employed, in which the region setting valid bit is asserted if data size indicating a size of a non-cache region is set “0.” This configuration can be easily implemented by employing a configuration in which an OR type decode circuit is simply used to decode size data (SIZE) to deassert the region setting valid bits applied to NAND gates (15a to 15k) when all bits of size data are “0.”

As described above, according to the first embodiment of the present invention, even if an access to an address region set in a non-cache control register is an access to an address region assigned to the cache entry table, data transfer with the external memory can be performed through a bus control circuit without updating the contents of the cache entry table when the address region is set into a non-cache region. Thus, an address space can be assigned according to a characteristic of an I/O device, and a user can set a non-cache region variable in size desirably while holding high speed data transfer performance between a CPU core and the cache entry table. Thus, a high speed processor system high in versatility can be implemented.

Moreover, in order to set a non-cache object region, there is no need to prepare a region having substantially the same size as a cache region. By selectively using a cache object region as a non-cache region, a size of an address space can be reduced, enabling reduction in number of address bits.

Second Embodiment

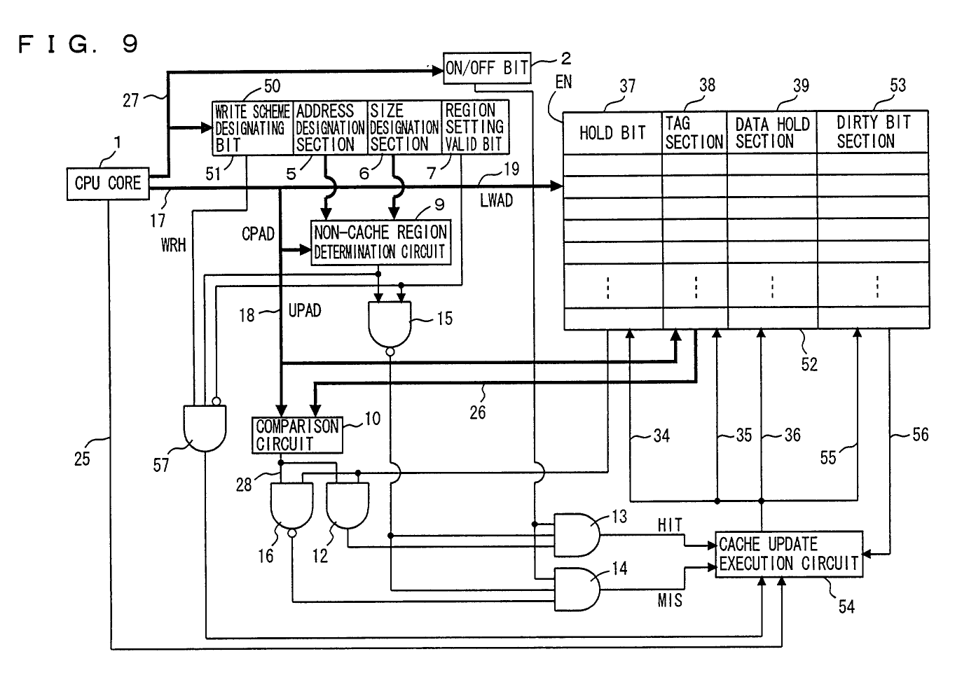

FIG. 9 is a diagram schematically showing an overall configuration of a cache controller according to a second embodiment of the present invention. In FIG. 9, in the cache controller, a non-cache region setting register 50 includes: address designation section 5 storing a start address of a non-cache region; size designation section 6 storing data indicating a size of the non-cache region; and region setting valid bit section 7 storing a region setting valid bit indicating whether or not a corresponding region is set as a non-cache region, as in the first embodiment. In addition, the cache controller further includes a write scheme designating bit section 51 for storing a write scheme designating bit designating which of the copy-back scheme and the write-through scheme is employed as a write scheme for a cache region.

In order to change a write scheme in a specific cache region, the cache controller includes a gate circuit 57 receiving a write scheme designating bit of write scheme designating bit section 51, an output signal of non-cache region determination circuit 9 and a region setting bit stored in region setting valid bit section 7. An output signal of gate circuit 57 is applied to cache update execution circuit 54.

When a region setting valid bit stored in region setting valid bit section 7 is in reset state and indicates that an object region is not a non-cache region, that is the object region is a cache region and non-cache region determination circuit 9 indicates that an address-designated region is included in a region designating a write scheme, then gate circuit 57 outputs a signal instructing whether or not the copy-back scheme is performed according to write scheme designating bit WRH stored in write scheme designating bit section 51.

Write scheme designating bit WRH is set to “1” (H level) when designating the copy-back scheme, while it is set to “0” (L level) when designating the write-through scheme. The cache controller employs the write-through scheme as a default write scheme upon cache hit in a cache object region.

In order to implement the copy-back scheme, a cache entry table 52 includes a dirty bit section 53 for storing a dirty bit indicating whether or not data stored in data hold section 39 coincides with data in a corresponding address region of external memory in each entry EN.

When the copy-back scheme is designated, cache update execution circuit 54, upon cache hit, simply performs overwriting of data in data hold section 39 of a corresponding entry in cache entry table 8 and sets a corresponding dirty bit. Upon cache miss, cache update execution circuit 54 reads a dirty bit stored in corresponding dirty bit section 53 through signal line 56 to determine whether or not transfer of data of a corresponding entry (write-back to external memory) is to be performed.

The other components of the configuration of the cache controller shown in FIG. 9 is the same as corresponding components of the configuration of the cache controller shown in FIG. 1, corresponding components are denoted with the same reference numerals and detailed description thereof is not repeated.

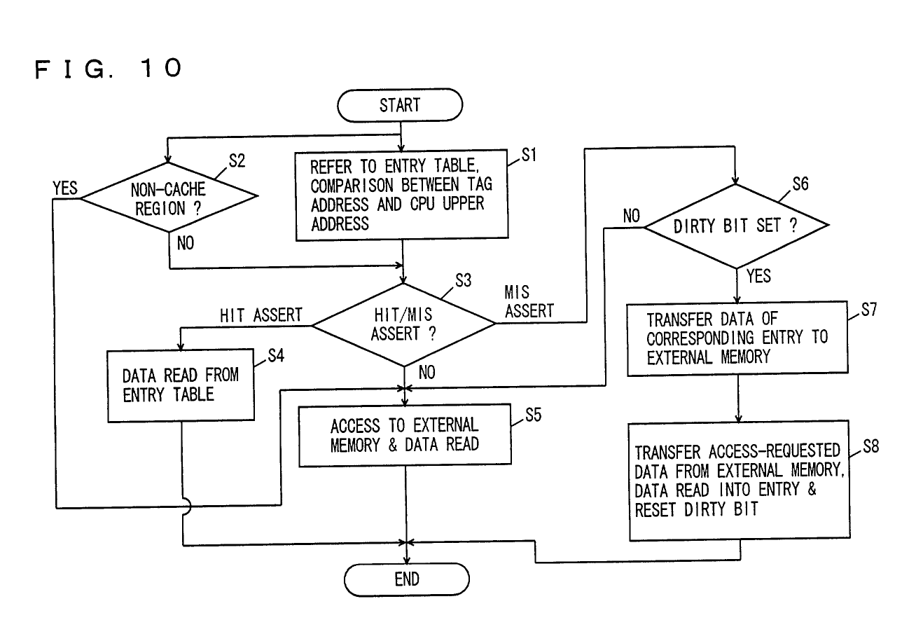

FIG. 10 is a flow chart representing an operation of the cache controller shown in FIG. 9 upon data reading. Description will be given of operation of the cache controller shown in FIG. 9 upon data reading below, with reference to FIG. 10.

First, access from CPU core 1 is made and CPU address CPAD is outputted onto address bus 17. A held bit in hold bit section 37 and a tag address in tag section 38 of a corresponding entry from cache entry table 52 are read according to an associated lower address LWAD on address bus 19. Furthermore, at this time, in non-cache region setting register 50, a start address stored in address designation section 5 and region size data stored in size designation section 6 are read out and are applied to non-cache region determination circuit 9. In addition, a region setting valid bit is read from region setting valid bit section 7.

Then, comparison between the tag address on tag address bus 26 and CPU upper address UPAD on upper address bus 18 is performed in comparison circuit 10 (step S1).

In parallel to this comparison operation, a determination is made on whether or not an addressed address is an address in a non-cache region (step S2). When an on/off bit in cache control register 2 is in the off state, output signals HIT and MIS of AND circuits 13 and 14 are both at L level. Since an access object is a non-cache region, bus control circuit 282 operates regardless of a comparison result, to access external memory and to read necessary data (step S5).

In non-cache region determination circuit 9, when an address requested of access by CPU core 1 is an address in a region set as a non-cache region in a cache object region, an output signal of NAND circuit 15 attains L level to indicate an access to a non-cache region. Similar to the case when the on/off bit is the on state, the procedure advances to the step S5, and an access to external memory is made to read necessary data therefrom.

On the other hand, when non-cache region determination circuit 9 determines that a region setting valid bit in region setting valid bit section 7 is set in the valid state and an address in a region different from a non-cache region is designated (step S2), cache hit indicating signal HIT and cache miss indicating signal MIS are selectively activated according to an output signal of comparison circuit 10 and a value of a hold bit of a selected entry from cache entry table 52 (step S3).

When cache hit signal HIT is asserted and cache miss signal MIS is deasserted, cache update execution circuit 54 selects a word of data stored in data hold section 9 of a selected entry of cache entry table 52 according to lower address LWAD from CPU core 1 and transfers the selected word to CPU core 1.

When cache miss indicating signal MIS is asserted, a determination is made on whether or not a dirty bit stored in the dirty bit section 53 is set in a selected entry (step S6). If the dirty bit is set, data of a corresponding entry is transferred to an original address region in external memory since stored data in data hold section 39 of a selected entry is different in contents from stored data in external memory (step S7). Data transfer between CPU core 1 and external memory is performed under control of bus control circuit, while operations for reading corresponding data from cache entry table 52 to apply the data to bus control circuit is performed by a cache update execution circuit 54.

After data of a corresponding entry is transferred to the external memory, cache update execution circuit 54 reads an entry, including data requested of access, applied from external memory into a corresponding entry of cache entry table 53 under control of bus control circuit 282 and then, resets the dirty bit in dirty bit section 53 through signal line 55 (step S8).

In determination block S3, when the on/off bit is in the off state and access to a set non-cache region is made, since signals HIT and MIS are both in a deassert state, cache update execution circuit 54, determines that access to a region other than a cache object region is made to make access to the external memory for reading necessary data (this operation is performed under control of bus control circuit).

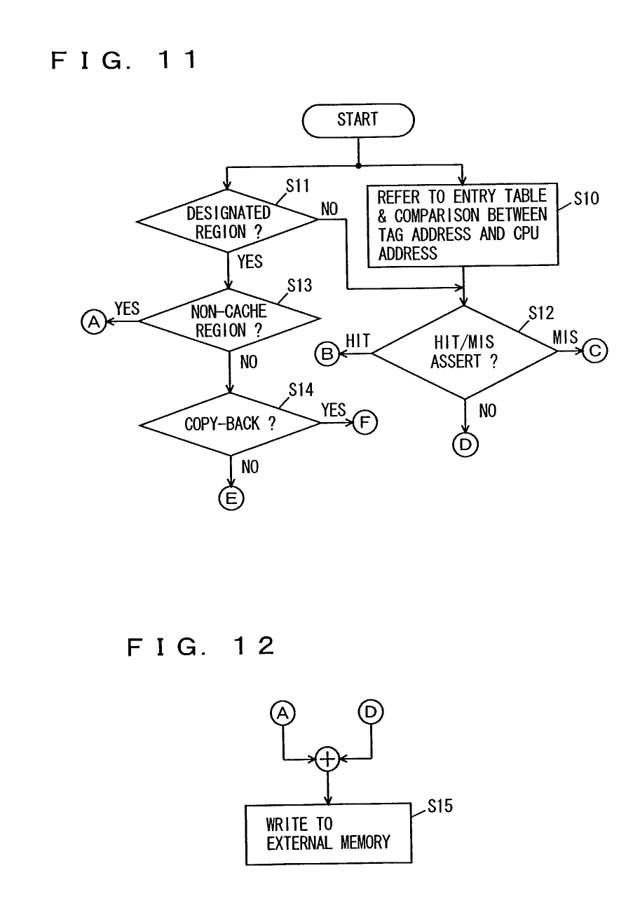

Then, description will be given of operation of the cache controller in data writing, with reference to flow charts shown in FIGS. 11 to 14.

First, CPU core 1 outputs CPU address CPAD onto address bus 17. Non-cache region determination circuit 9 determines whether or not access to a designated region is made according to a start address stored in non-cache region setting register 50 and region size information (step S11). In cache entry table 52, an entry is selected according to lower address LWAD from CPU core 1 to transfer a corresponding tag address to comparison circuit 10 through tag address bus 26. In comparison circuit 10, comparison is performed between the read tag address and upper address UPAD from CPU core 1 (step S10).

When non-cache region determination circuit 9 determines that a region set in non-cache region setting register 50 is designated, then a determination is made by NAND circuit 15 on whether or not access to the non-cache region is requested according to a region setting valid bit stored in region setting valid bit section 7 (step S13).

When non-cache region determination circuit 9 determines that access to a region set as a non-cache region is made, a region setting valid bit of region setting valid bit section 7 is in the reset state and a corresponding region is not set as a non-cache region, that is, when the set region is not designated as a cache region, a determination is made by gate circuit 57 on whether or not the copy-back scheme is set according to a write scheme designating bit (step S14).

When in step S11, it is determined that a region different from the designated region is accessed, that is, it is determined that access to a cache region or a non-cache object region is made, a determination is made by cache update execution circuit 54 on whether or not the signal HIT or MIS is asserted according to an output signal of comparison circuit 10, a signal of a hold bit form hold bit section 37 stored in an selected entry and the on/off bit stored in cache control register 2. Subsequent processing is different in contents according to determination results in steps S13, S14 and S12.

When in step S13, the designated region is set as a non-cache region, or in step S12, the signals HIT and MIS are both in the deassert state, if the on/off bit is set in the off state, data write to the external memory is performed as shown in FIG. 12, since access to non-cache object region is made, or alternatively an access to a non-cache region in a cache object region. (step S15) is made.

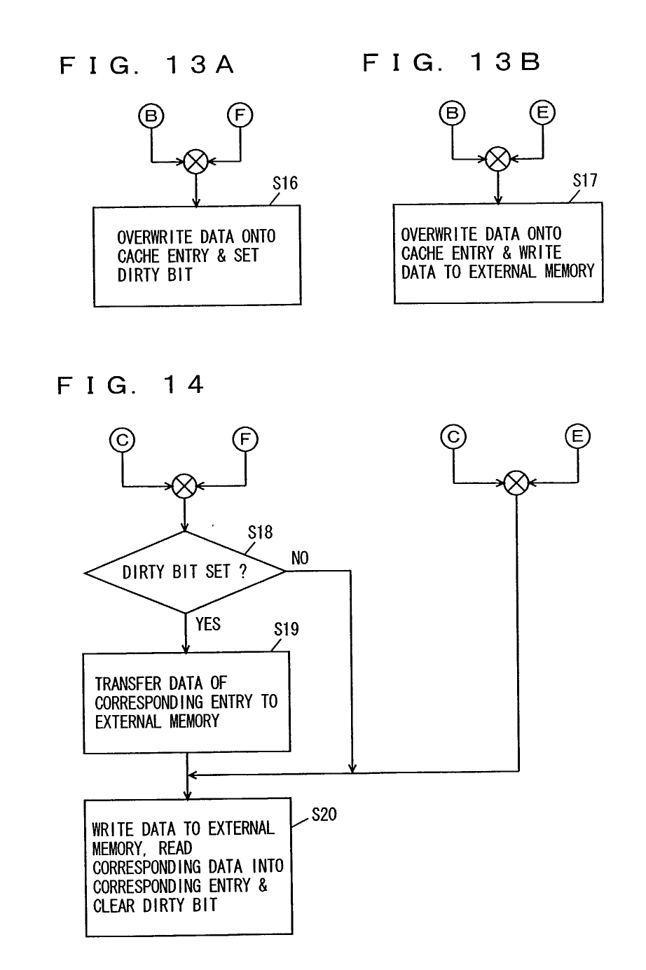

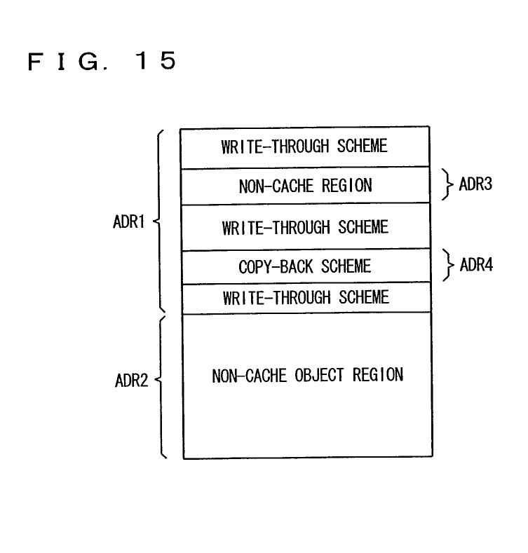

On one hand, when in steps S12 and S14, cache hit signal HIT is asserted and the copy-back scheme is designated, overwrite of data is performed on a corresponding entry of cache entry table 52 as shown in FIG. 13 and a dirty bit of corresponding dirty bit section 53 is set (step S16).

On the other hand, when cache hit signal HIT is asserted, the copy-back scheme is not designated and the write-through scheme of a default is designated as shown in FIG. 13, overwrite of data is performed on a corresponding entry of cache entry table 52 and in parallel to this operation, write of data is performed to a corresponding address of the external memory (step S17). At this time, a step of setting a dirty bit to the reset state may be performed.

Furthermore, when in the determination step S13, cache miss is determined and cache miss signal MIS is asserted and when in step S14, it is determined that the copy-back scheme is set by a write scheme designating bit, a determination is first made on whether or not a dirty bit of dirty bit section 53 of a corresponding entry is set, as shown in FIG. 14 (step S18). If the corresponding dirty bit is set, transfer of data stored in data hold section 39 of a corresponding entry is first performed under control of cache update execution circuit 54 and bus controller since storage contents of data hold section 39 of the corresponding entry and contents of a corresponding address region of the external memory do not coincide with each other (step S19).

After data transfer of contents of a corresponding entry to the external memory is performed, data block requested of access by CPU core 1 is then written to the corresponding entry of cache entry table 52. Subsequently, write data is overwritten on the contents of a selected entry. In this case, a corresponding dirty bit is set since the contents of the selected entry of the cache entry table is different from the contents of a corresponding address in the external memory.

In the data writing to the corresponding entry, write data may be overwritten on transferred data prior to writing to the entry. Furthermore, data write is performed to external memory (for example, a read-modify-write cycle is performed to update read data from the external memory with write data, to update data in the external memory as well as to update read data from the external memory with write data).

Moreover, cache update execution circuit 54 clears a corresponding dirty bit to indicates that data in data hold section 39 newly stored into cache entry table 52 coincide with stored data of the external memory (step S20).

On the other hand, when the copy-back scheme is not designated but the write-through scheme is designated, data block applied from external memory and overwritten with write data is simply written into a corresponding entry of cache entry table 52, upon cache miss in step S20 (step S20). At this time as well, a dirty bit is cleared for confirmation. In this case, write of write data to the external memory is also performed.

Meanwhile, upon cache hit in a case where the write-through scheme is designated and write of data is performed into a designated region, a configuration may be employed, in which the corresponding contents of cache entry table 52 are overwritten with write data and a dirty bit of dirty bit section 53 is set to “1”. In this case, since when data is written upon cache hit, a dirty bit is set in any of the write-through scheme and the copy-back scheme, a control operation of cache update execution circuit 54 can be simplified.

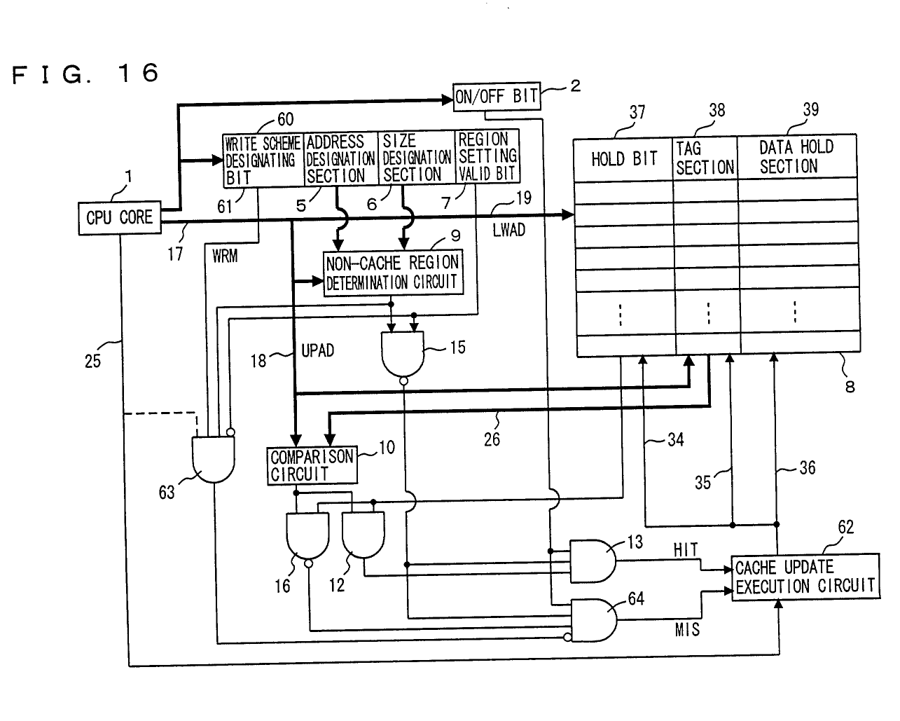

Therefore, when cache object region ADR1 and non-cache object region ADR2 are present in a memory address space as shown in FIG. 15, a non-cache region ADR3 can be set in cache object region ADR1 by the non-cache region setting register. Moreover, by using non-cache setting register 50 to set a write scheme designating bit and to set a region setting valid bit into an invalid state, an address region ADR4, for example, can be set to a region subject to data writing in the copy-back scheme in cache object region ADR1. In the other region of cache object region ADR1, data write is performed according to the write-through scheme upon cache hit.

As described above, by storing a write scheme designating bit in non-cache region setting register, not only can a non-cache region be set in a cache object region, but also a write scheme can be selected for each access region in the cache object region.

By selectively using the write-through scheme and the copy-back scheme according to contents of processed data, not only can performance of an entire system be improved, but the system high in versatility can also be constructed. For example, in a case where the external memory is a common memory shared with another system and change in data through use by CPU core 1 is required to be always reflected in the external memory, such an address region is used in the write-through scheme, while a specific address region of the external memory is used mainly by CPU core 1 and not shared with another device, the copy-back scheme is employed to write data to implement high speed processing.

With such configuration, by changing a write scheme of data according to an architecture of the system, an architecture high in versatility can be achieved and a system can be implemented that is adaptable to any of the write-through scheme and the copy-back scheme.

It should be noted that in the second embodiment as well, a plurality of non-cache region setting registers 50 may be provided in parallel (see FIG. 8).

Third Embodiment

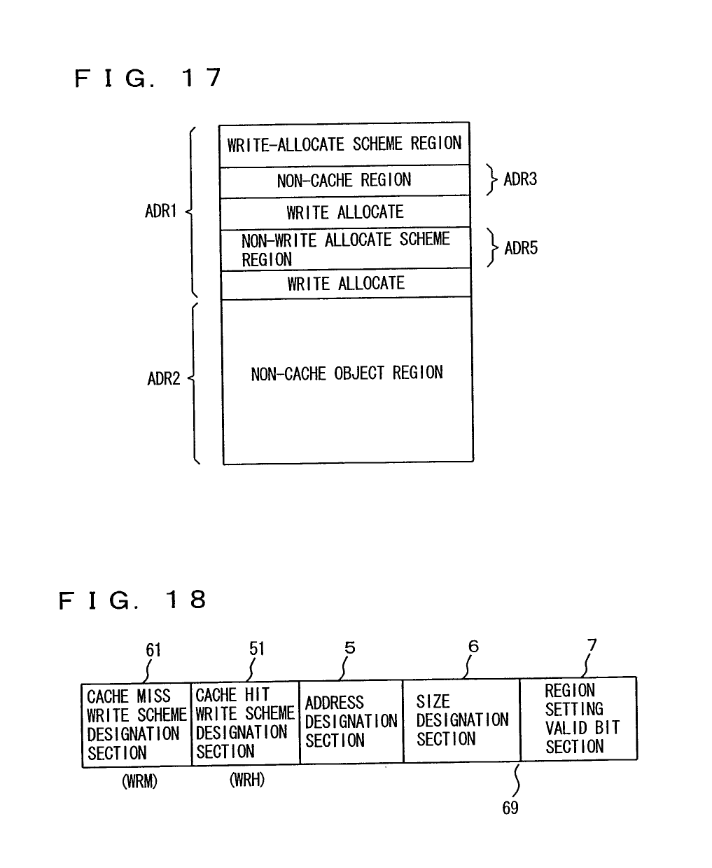

FIG. 16 is a diagram schematically showing a configuration of a cache controller according to a third embodiment of the present invention. In the cache controller shown in FIG. 16, there is provided, in non-cache region setting register 60, a write scheme designating bit section 61 storing a write scheme designating bit WRM for setting a data write scheme upon cache miss. As in the first and second embodiments, non-cache region setting register 60 includes: address designation section 5 storing a start address of a non-cache region; size designation section 6 storing data indicating a size of a non-cache region; and a region setting valid bit section 7 storing a bit for setting a corresponding region as a non-cache region.

In order to control an operation upon cache miss, the cache controller includes: a gate circuit 63 receiving a write scheme designating bit WRM stored in write scheme designating bit section 61, an output signal of non-cache region determination circuit 9 and a region setting valid bit stored in region setting valid bit section 7; and a gate circuit 64 receiving an output signal of gate circuit 63, an output signal of NAND circuit 16, an output signal of NAND circuit 15 and an on/off bit to generate cache miss signal MIS. Non-cache region determination circuit 9, NAND circuit 15 and NAND circuit 16 are the same as in the configurations shown in the first and second embodiments.

The cache controller is not equipped with dirty bit section since data is written in cache entry table 8 according to the write-through scheme upon cache hit. Cache update execution circuit 62 executes reading and updating of data stored in hold bit section 37, tag section 38 and data hold section 39 of cache entry table 8.

Write scheme designating bit WRM stored in write scheme designating bit section 61 indicates a state of non-write allocate mode when set. That is, upon cache miss, no updating of contents of cache entry table 8 is performed, but data write is performed only to the external memory.

Cache update execution circuit 62 performs updating of an entry according to the write-allocate scheme in clear state (reset state) of write scheme designating bit WRM. That is, after contents of cache entry table 8 are updated using data transferred from external memory, overwrite on a corresponding entry of cache entry table 8 is performed with write data. That is, the write-allocate scheme is set as a default upon cache miss.

Gate circuit 63 outputs a signal at H level when write scheme designating bit WRM is set, an output signal of non-cache region determination circuit 9 is asserted to indicate that an access to a region set in non-cache region setting register 60 is made and a region setting valid bit stored in region setting valid section 7 is in a reset (clear) state. Therefore, when an access to an object region is performed under a state where the object region is a cache region and a non-write allocate scheme is set, gate circuit 63 outputs a signal at H level.

Gate circuit 64 asserts/deasserts cache miss indicating signal MIS according to an output signal of NAND circuit 16 when an on/off bit is in a set state to indicate an operation in the cache mode, an output signal of NAND circuit 16 is at H level to indicate the absence of corresponding data in cache entry table 8, access to a region different from a region set as a non-cache region is made and the write allocate scheme is designated (in which a write scheme designating bit WRM is in a reset state).

Now, description will be given of operation of the cache controller shown in FIG. 16.

When an on/off bit stored in cache control register 2 is in the off state, cache hit indicating signal HIT and cache miss indicating signal MIS are both at L level and cache update execution circuit 62 determines that a non-cache object region is accessed and does not update cache entry table 8. An access is made to the external memory under control of bus control circuit.

When an on/off bit is in the on state, access to a cache object region is made. When an address region different from the address region set in non-cache region setting register 60 is accessed, an output of NAND circuit 15 is at H level and an output signal of gate circuit 63 is at L level. Hence, in this situation, one of cache hit signal HIT and cache miss signal MIS is activated according to coincidence/non-coincidence between a tag address read from cache entry table 8 and upper address UPAD from CPU core 1. When cache hit indicating signal HIT is asserted, access is made to data stored in data hold section 39 of a corresponding entry of cache entry table 8. (in any of data write mode and read mode).

When cache miss indicating signal MIS is in an active state at H level, cache update execution circuit 62 transfers data stored in corresponding data hold section 39 of cache entry table 8 to a corresponding address region of the external memory regardless of data write or data read since the write-allocate scheme as a default for data write is set. Thereafter, data requested of access is read out from external memory to be stored in a corresponding data hold section 39 of cache entry table 8. Furthermore, when data is written, cache update execution circuit 62 not only overwrites write data on stored data of data hold section 39 of a corresponding entry but also transfers the write data to the external memory for writing at a corresponding address of the external memory.

Then, description will be given of operation when an address region set in non-cache region setting register 60 is accessed.

In this situation, when a region setting valid bit stored in region setting valid bit section 7 is in a valid state, an output signal of non-cache region determination circuit 9 attains H level. The region setting valid bit is at H level, an output signal of NAND circuit 15 attains L level and cache hit signal HIT and cache miss signal MIS are both driven to L level. Therefore, cache update execution circuit 62 determines that a region other than a cache object region is accessed and therefore, performs no updating of cache entry table 8.

When region setting valid bit is set in an invalid state (reset state or clear state) and an address region defined by data stored in address designation section 5 and size designation section 6 is accessed, an output signal of non-cache region determination circuit 9 is at H level, while a region setting valid bit is at L level. Thus, an output signal of NAND circuit 15 attains H level.

An output signal of gate circuit 63 attains H or L level according to write scheme designating bit WRM.

When data of a designated address region is stored in cache entry table 8, an output signal of comparison circuit 10 turns H level, and therefore, cache hit indicating signal HIT from AND circuit 13 is activated, while cache miss indicating signal MIS is deactivated.

Therefore, cache update execution circuit 62 reads, in data reading, data of data hold section 39 of a corresponding entry to transfer the data to CPU core 1, while in writing data, overwrites write data on data hold section 39 of a corresponding entry, and in a case where the write-through scheme is set as a default value, transfers the write data to the external memory for writing. In a case where the copy-back scheme is set, only overwrite of write data on data hold section 39 and setting of a dirty bit not shown are performed. Therefore, upon cache hit, an output signal of gate circuit 63 exerts no influence on update operation on cache entry table 8.

Now, a case is considered where when an address region set in non-cache setting register 60 is accessed and no corresponding data is present in cache entry table 8, and further where a region setting valid bit is set in a reset state (invalid state). In this situation, an output signal of NAND circuit 15 is at H level and an output signal of comparison circuit 10 is at L level since data requested of access is not present in cache entry table 8. Therefore, cache hit signal HIT turns L level.

When write scheme designating bit WRM is set to H level to indicate a state of no write allocation in this situation, an output signal of gate circuit 63 attains H level to turn cache miss signal MIS from gate circuit 64 to L level. Therefore, since cache hit signal HIT and cache miss signal MIS are both at L level, cache update execution circuit 62 does not update cache entry table 8, but makes an access to the external memory for performing data transfer in any of data write and read modes.

When write scheme designating bit WRM is set to L level to designate the write allocate scheme, gate circuit 54 drives cache miss signal MIS to H level since an output signal of gate circuit 63 is at L level. Hence, cache update execution circuit 62, in this situation, first performs transfer of stored data of data hold section 39 of a corresponding entry to the external memory and thereafter, stores data requested of access and applied from the external memory into data hold section 39 of the corresponding entry. Then, overwrite of write data on corresponding data hold section 39 is performed (in this case, writing of write data into the external memory is also performed in a similar manner) (in data write mode).

In data read mode, updating of contents of cache entry table 8 is simply performed by data transferred from the external memory.

Therefore, in the configuration of the cache controller shown in FIG. 16, in a case where write scheme designating bit WRM stored in write scheme designating bit section 61 is set and non-write allocate scheme is set as a write scheme, upon cache miss in any of data write and read modes, no updating of contents of cache entry table 8 is performed, but only access to the external memory is made.

If write mode instructing signal (write access instructing signal) from CPU core 1 is applied to gate circuit 63 as shown with a broken line in FIG. 16, an output signal of gate circuit 63 maintains the L level since write access instructing signal (write mode instructing signal) is at L level in data read mode. Therefore, updating of cache entry table 8 is performed, on an address region set to be subject to no write allocation, in data read mode by transfer of data of a corresponding entry to the external memory and transfer of corresponding data from the external memory according to determination on cache hit/cache miss.

That is, in a case where a write access instructing signal is applied to gate circuit 63 as shown with a broken line in FIG. 16, and the write allocate scheme is employed as a default upon write cache miss, transfer of data to the external memory and updating of contents of an entry are performed regardless of application of the write allocate scheme when cache miss is caused in data reading.

In data writing, write access instructing signal applied onto signal line 25 from CPU core 1 is driven to H level, and gate circuit 63 can set a data write scheme upon cache miss according to data/bit set in cache region setting register 60.

Therefore, by using the write scheme designating bit as shown in FIG. 16, in cache object region ADR1, as shown in FIG. 17, region ADR3 can be set as a non-cache region and a region ADR5 can be set as a region in which data write is performed in the non-write allocate scheme. Data is written upon cache miss according to the write allocate scheme in a remaining region of cache object region ADR1.

Therefore, a data write scheme upon cache miss can be set to any of the write allocate scheme and the non-write allocate scheme according to contents of data, to allow setting of an address region according to a system architecture with flexibility.

Modification

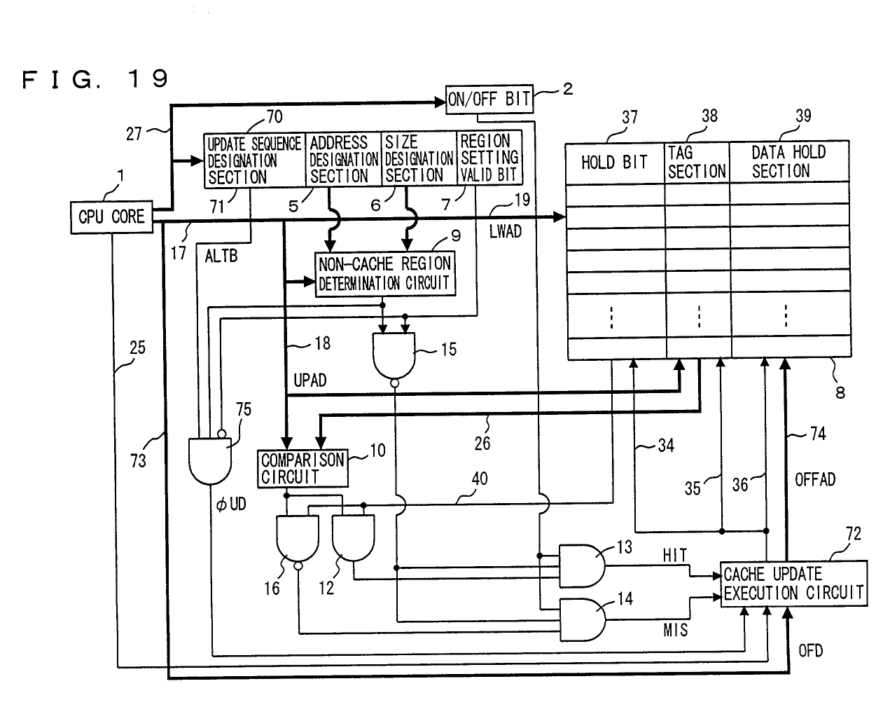

FIG. 18 is an illustration showing a construction of non-cache region setting register 69 according to a modification of the third embodiment of the present invention schematically. Non-cache region setting register 69 shown in FIG. 18 includes: a cache miss write scheme designation section 61 storing a bit WRM designating a write scheme upon cache miss; a cache hit write scheme designation section 51 storing a bit WRM designating a write scheme upon cache hit; address designation section 5 storing a start address of a specific address region in a cache object region; size designation section 6 storing data designating a size of the specific address region; and a region setting valid bit section 7 storing a setting valid bit indicating whether or not the addressed region is set as a non-cache region.

In the construction of non-cache region setting register 69 shown in FIG. 18, write schemes upon cache hit and upon cache miss can be set by respective bits WRH and WRM. Therefore, in a specific address region, data write upon cache hit can be performed in one of the copy-back scheme and the write-through scheme, while data write upon cache miss can be performed in one of the write-allocate scheme and the non-write-allocate scheme. With such configuration employed, a data write scheme can be set according to a characteristic of processing data with flexibility.

As described above, according to the third embodiment of the present invention, a data write scheme upon cache miss can be set for each desired address region and assignment of an address region can be performed according to a characteristic of processing data, thereby improving a performance of a whole system and further, achieving a construction of the system high in versatility.

Fourth Embodiment

FIG. 19 is a diagram schematically showing a configuration of a cache controller according to a fourth embodiment of the present invention. In the configuration of the cache controller shown in FIG. 19, there is provided, in a non-cache region setting register 70, an update sequence designation section 71 storing an update sequence designating bit designating an updating sequence of a plurality of words included in an entry upon cache miss. Non-cache region setting register 70 further includes: address designation section 5 storing a start address of a specific address region of a cache object region; size designation section 6 storing size data of the specific address region; and region setting valid bit section 7 storing a region setting valid bit indicating whether or not the specific address region is set as a non-cache region, similar to the first to third embodiments.

In order to set an update sequence of words in an entry upon cache miss, there is provided, in the cache controller, a gate circuit 75 receiving an output signal of non-cache region determination circuit 9, the region setting valid bit and update sequence designating bit ALTB. An output signal φUD of gate circuit 75 is applied to a cache update execution circuit 72 together with a word offset address OFD applied through an offset address bus 73 from CPU core 1.

In a case where an output signal of gate circuit 75 is at H level upon cache miss and an update sequence starts at an address requested of access by CPU core 1, cache update execution circuit 72 generates an offset address OFFAD designating a word in an entry according to offset address OFD from CPU core 1 to apply generated offset address OFFAD to cache entry table 8 through an offset address bus 74.

In the configuration of the cache controller shown in FIG. 19, determination on cache hit/cache miss and determination on cache/non-cache are performed similarly to the first embodiment.

Therefore, when an output signal φUD of gate circuit 75 is at H level, alteration of a plurality of words stored in data hold section 39 of an entry in cache entry table 8 is started at a word at an address requested of access by CPU core 1. In this case, a plurality of words in one entry are sequentially updated according an offset address.

For example, in a case where 4 words are stored in one entry, a 2-bit address is used as offset address OFFAD. In a case where the address is sequentially updated from “00” to “11,” it is a normal updating sequence. When offset address OFD of a word that CPU core 1 accesses is, for example, “01,” offset address OFFAD is updated in the sequence of “01”, “10”, “11” and “00”, and data transfer to the external memory is performed. By changing addresses according the wraparound scheme, data requested by CPU core 1 can be first transferred to thereby perform data transfer with high efficiency to improve the system performance.

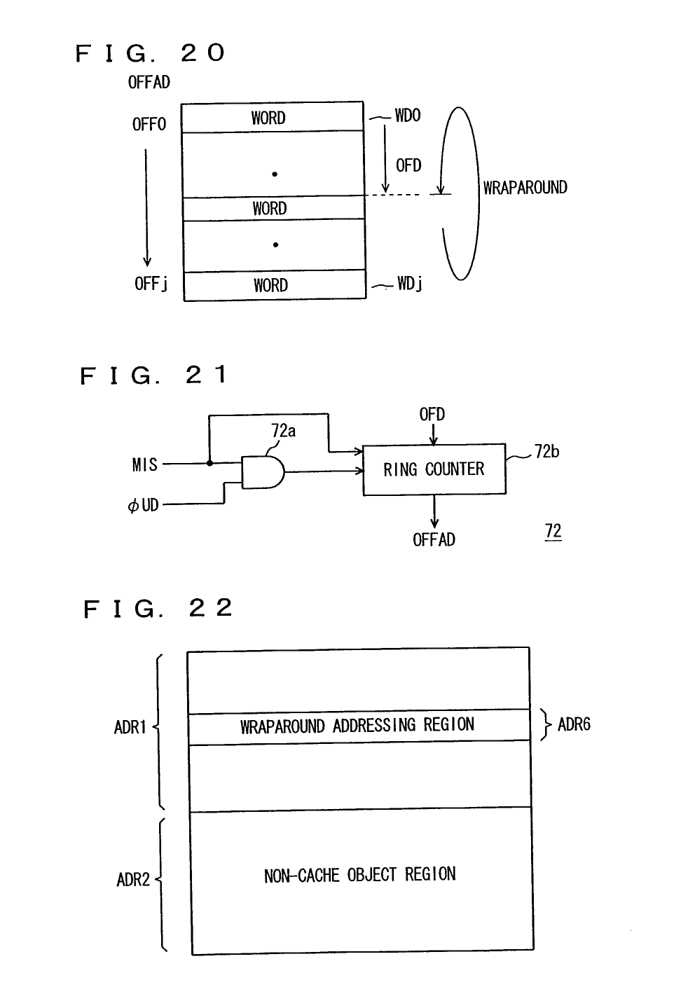

Specifically, as shown in FIG. 20, a case is considered, in which a plurality of words WD0 to WDj are stored in data hold section 39 of one entry. As offset addresses OFFAD, OFF0 to OFFj are assigned to respective words WD0 to WDj. In a case where an offset address of data word requested of access by CPU core 1 is OFFAD, and update sequence designating bit ALTB stored in update designation section 70 is in a valid state, an address is sequentially incremented with offset address OFD bieng a start address to alter the address through the last offset address OFFj and thereafter, returns back to the minimum word address OFF0 to update the address sequentially to the next offset address OFD.

Data transfer operation in the cache controller shown in FIG. 19 upon cache hit/cache miss is the same as in the case of the first embodiment. Upon cache miss, cache update execution circuit 72 updates a sequence of updating the contents in a to-be-updated entry according to update sequence designating bit ALTB.

FIG. 21 is a diagram showing an example of a configuration of a section related to offset address OFFAD of cache update execution circuit 72 shown in FIG. 19. In FIG. 21, cache update execution circuit 72 includes: an AND circuit 72a receiving cache miss indicating signal MIS from AND circuit 14 and output signal φUD of gate circuit 75 shown in FIG. 19; and a ring counter 72b having offset address OFD from offset address bus 73 set as an initial value when an output signal of AND circuit 72a is at H level and performing a count operation upon cache miss. Offset address OFFAD is outputted from ring counter 72b.

Upon cache hit and when an access to a region different from a cache object region is made, an output signal of AND circuit 72a and cache miss indicating signal MIS are both at L level. Upon cache hit, no necessity arises for updating of an entry and the counter performs no count operation.

In the write-through scheme, although data write is performed, it is limited on a word of an access target and a word is selected according to a word address (offset address), which is a CPU lower address.

In the write-through scheme upon cache hit, CPU offset address OFD may be set as an initial value in ring counter 72b. In addition, offset address OFFAD for the cache entry table may be generated according to a CPU offset address, with ring counter 72b bypassed.

On the other hand, when an output signal of AND circuit 72a is at L level upon cache miss, ring counter 72b starts a count operation from “00” of a default value for an initial value.

On the other hand, when an output signal of AND circuit 72a is at H level upon cache miss, ring counter 72b has offset address OFD from offset address bus 73 set for an initial value of the count. Therefore, upon cache miss, ring counter 72b generates offset address (word address) OFFAD according to wraparound addressing starting at offset address OFD.

FIG. 22 is an illustration showing assignment in this addressing scheme schematically. In FIG. 22, the wraparound addressing scheme is set as an addressing scheme upon cache miss for a region ADR6 of cache object region ADR1. In a remaining region of cache object region ADR1, addressing is sequentially performed starting at a start word address of data hold section 39 of an entry according to the non-wraparound addressing scheme.

In order to achieve high speed processing, in a case where a data transfer scheme is fixed to the wraparound scheme and when as an external unit, a memory capable of performing a so-called burst transfer operation is provided, the memory is required to be a device capable of making wraparound access. For this case, there exists a memory capable of performing a burst transfer operation but being accessible only in the non-wraparound scheme. Accordingly, in such a case, there arises a limitation on kinds of external memories that can be employed, to reduce versatility of a system.

However, by setting the wraparound addressing scheme/the non-wraparound addressing scheme for each address region, an external device addressable in the non-wraparound scheme in the burst transfer can be connected, thereby enabling versatility of the system to be maintained.

Furthermore, in a case where the wraparound addressing scheme is set over an entire of cache object region ADR1 as an addressing scheme in data transfer, for a device not capable of the wraparound accessing, a circuit performing rearrangement of data according to offset addresses has to be arranged as a bus interface circuit, causing a problem of an increased system scale. However, by selectively setting an address region of a given size into a region for the wraparound addressing scheme, it is only required to assign a region for which data transfer is performed in the normal non-wraparound addressing to a device that can not be accessed in a wraparound addressing scheme, thereby allowing reduction in system scale without any degradation of a system performance.

In other words, in a case where increase in system scale is permitted to some extent, a circuit performing data rearrangement according to offset addresses in the bus interface circuit may be used for the external memory corresponding to a wraparound address region.

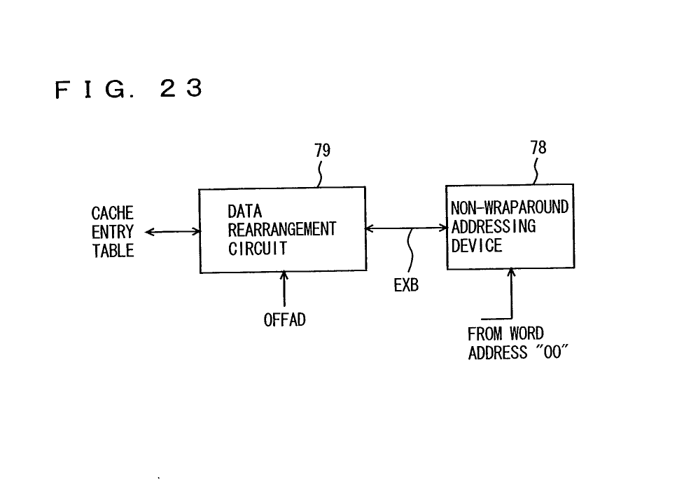

Specifically, as shown in FIG. 23, in a case where a non-wraparound addressing device 78 is coupled to cache entry table 8 through an external bus EXB, a data rearrangement circuit 79 performing data rearrangement according to offset address OFFAD is provided in bus interface section. With data rearrangement circuit 79, data transfer between cache entry table 8 and external memory is performed. In accordance with the address region, offset address OFFAD is generated from a start address of data hold section of an entry, or using an address of data requested of by CPU core 1 as a start address.

Using data rearrangement circuit 79, an entry address and CPU upper address UPAD are normally applied to non-wraparound addressing device 78. Data transfer is performed with lowest word address bits of “00” being an initial value (in a case where one entry contains 4 words). Even if word addresses are generated according to the wraparound addressing scheme for performing burst transfer in CPU while non-wraparound addressing device 78 is capable of performing a burst transfer and always performs data selection internally from addresses starting at a word address of “00”, necessary data can be transferred through external bus EXB by using data rearrangement circuit 79.

Since when data requested of access by CPU core 1 is applied to data rearrangement circuit 79 in CPU, the requested data is first applied to CPU core 1, the performance is not different from a performance in a case where ordinary non-wraparound addressing device 78 is used as an external memory device.

As described above, according to the fourth embodiment of the present invention, since data is transferred starting at data that requested by CPU core 1 upon cache miss and this addressing scheme can be set for a region of a desired range in the cache object region. A high speed data transfer can be achieved and furthermore, by assigning address regions individually to a wraparound addressing device and a non-wraparound addressing device, versatility of the system can be enhanced.

Fifth Embodiment

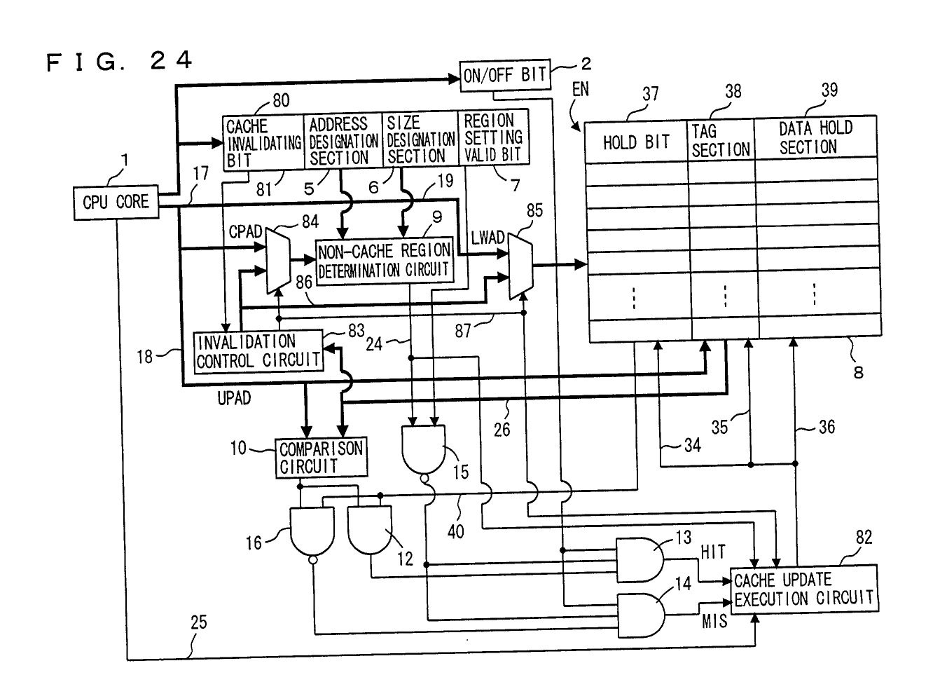

FIG. 24 is a diagram schematically showing an overall configuration of a cache controller according to a fifth embodiment of the present invention. In FIG. 24, there is provided, in a non-cache region setting register 80, a field 81 storing a cache invalidating bit for invalidating data in a set address region of data stored in cache entry table 8. Similarly to the first embodiment, non-cache region setting register 80 includes: address designation section 5 storing a start address of a prescribed address region; size designation section 6 storing data indicating a size of the address region; and a region setting valid bit section 7 storing a region setting valid bit indicating whether or not a set region is valid as a non-cache region.

In order to selectively invalidate stored data in cache entry table 8, the cache controller includes: an invalidating control circuit 83 receiving a tag address read out onto tag address bus 26 from cache entry table 8 to combine the tag address and an entry address internally to generate an invalidating address onto an invalidating address bus 86; a selector 84 selecting one of a prescribed number of bits of CPU address CPAD applied from CPU core 1 and a prescribed number of bits of an invalidating address from invalidating control circuit 83 under control of invalidating control circuit 83 to apply the selected prescribed number of bits to non-cache region determination circuit 9; and a selector 85 selecting one of lower address LWAD applied from CPU core 1 through address buses 17 and 19, and an invalidating entry address designating an entry of cache entry table 8 out of an invalidating address read out onto an invalidating address bus 86 from invalidating control circuit 83 under control of invalidating control circuit 83.

An invalidating control instructing signal of invalidating control circuit 83 is also applied to cache update execution circuit 82. In addition, in order to invalidate data in a designated address region of cache entry table 8 in an invalidating control operation, an output signal of non-cache region determination circuit 9 is applied to cache update execution circuit 82.

Therefore, cache update execution circuit 82 invalidates data of data hold section 39 of a corresponding entry in cache entry table 8 when invalidating control circuit 83 operates to invalidate cache data and when non-cache region determination circuit 9 determines that a designated region is selected. That is, a hold bit stored in a corresponding hold bit section 37 is reset (cleared).

The other components of the configuration of the cache controller shown in FIG. 24 are the same as those of the configuration of the cache controller shown in FIG. 1, corresponding components are denoted with the same reference numerals and detailed descriptions thereof will not be repeated.

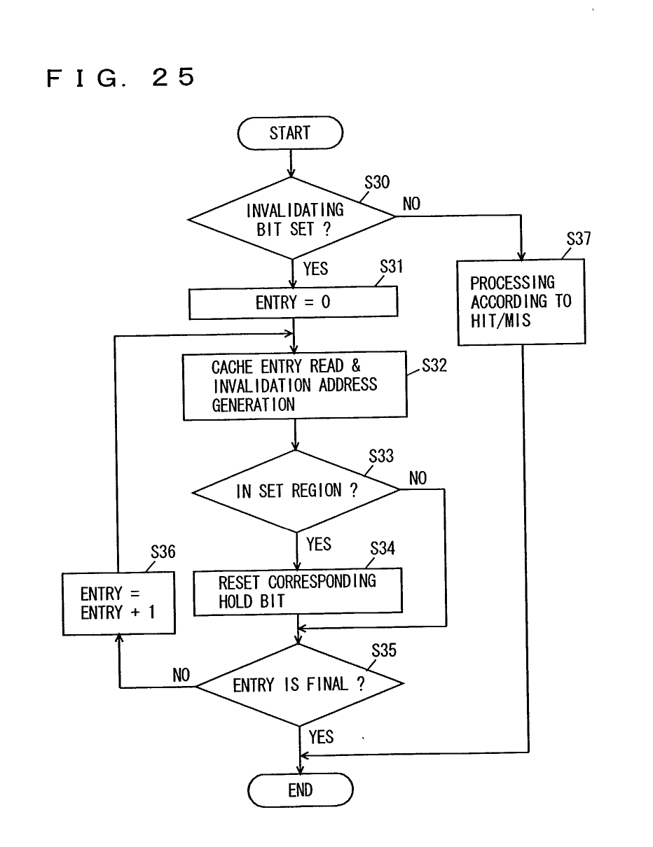

FIG. 25 is a flow chart representing an invalidating operation of the cache controller shown in FIG. 24. Description will be given of an operation in the cache controller shown in FIG. 24 below with reference to FIG. 25.

In order to invalidate cached data in a prescribed address region of cache entry table 8, a cache invalidating bit is first set in non-cache region setting register 80 and then, data indicating a start address and a size of a target address region are stored in address designation section 5 and size designation section 6, respectively. A region setting valid bit may be set in any of set state and reset state since no reference is particularly made thereto in a cache invalidating operation (step S30).

Invalidating control circuit 83 sets an entry address ENTRY to an initial value (“0”) in order to designate a start entry of cache entry table 8 when a cache invalidating bit is set in a valid state, for example, of “1” (step S31). Entry address ENTRY is then applied to cache entry table 8 through selector 85 to read out a tag address stored in tag section 38 of the start entry from cache entry table 8 through tag address bus 26.

Then, invalidating control circuit 83 combines the read out tag address and a prescribed number of bits of the entry address to generate an invalidating address and to transmit the invalidating address onto invalidating address bus 86 (step S32).

In a cache invalidating operation, selector 84 selects the invalidating address generated by invalidating control circuit 83 under control of invalidating control circuit 83 to apply the selected address to non-cache region determination circuit 9.

In non-cache region determination circuit 9, it is determined whether or not an address designated by the invalidating address is included in an address region set by address designation section 5 and size designation section 6 (step S33).

Cache update execution circuit 82 sets a hold bit stored in hold bit section 37 of a corresponding entry (a start entry) of cache entry table 8 to the reset state to invalidate storage contents of the start entry regardless of states of output signals HIT and MIS of respective AND circuits 13 and 14 when invalidating control circuit 83 indicates that an invalidating operation is performed and an output signal of non-cache region determination circuit 9 indicates that an invalidating address is present in the designated address region (step S34). By clearing a corresponding hold bit, hold data of the entry is invalidated.

On the other hand, when in step S33, it is determined by non-cache region determination circuit 9 that the invalidating address is not present in a set region, a state of a hold bit in a corresponding entry is not updated.

When processing on the start entry is completed, then a determination is performed on whether or not an entry is the last entry (step S35). Since the start address is not the last entry, entry address ENTRY is again incremented in step S36 to again perform processing from step S32. When such processing is repeated and processing on all entries of cache entry table 8 is completed, the invalidating processing is completed.

On the other hand, when a cache invalidating bit is in the reset state, invalidating control circuit 80 performs no forced invalidation of cache data in cache entry table 8.

Selector 84 selects a prescribed number of bits of CPU address CPAD applied from CPU core 1 to apply the selected bits to non-cache region determination circuit 9. Selector 85 selects lower address LWAD applied through address buses 17 and 19 from CPU core 1 to apply the selected lower address LWAD to cache entry table 8.

Therefore, non-cache setting register 80 functions as a register for setting a non-cache region in a cache object region when a cache invalidating bit is in the reset state.

That is, states of output signals HIT and MIS of AND circuits 13 and 14 are determined according to coincidence/non-coincidence between a tag address read out from cache entry table 8 and upper address UPAD of CPU address CPAD, a determination result of non-cache region determination circuit 9, a region setting valid bit and an on/off bit stored in cache control register 2. Cache update execution circuit 82 executes transfer/updating of contents of cache entry table 8 according to the signals HIT and MIS (step S37).

Therefore, by providing a region storing a cache invalidating bit in non-cache region setting register 80, only data included in a specific address region can be invalidated out of data stored in cache entry table 8 without invalidating all data of cache entry table 8.

Hence, by performing processing using data in an address region according to a program, and then invalidating the data required in execution of the program after completion of the processing, CPU core 1 can use, at a high speed, data for performing the next processing.

With such an architecture, there is no need to invalidate all cache data on an entire of cache entry table 8, thereby, enabling execution of the next processing at a high speed.

Meanwhile, in cache entry table 8, invalidation is performed in units of entries. However, setting of a non-cache region may be performed in units of upper addresses and moreover, may be performed on a basis of a region designated by a combination of an upper address and an entry address.

As described above, according to the fifth embodiment of the present invention, invalidation of cached data in a cache region is performed with each entry being the minimum unit. Thus, it is possible to selectively invalidate cached data of a necessary region, thereby enabling execution of efficient processing without invalidating data of an entire of the cache.

Sixth Embodiment

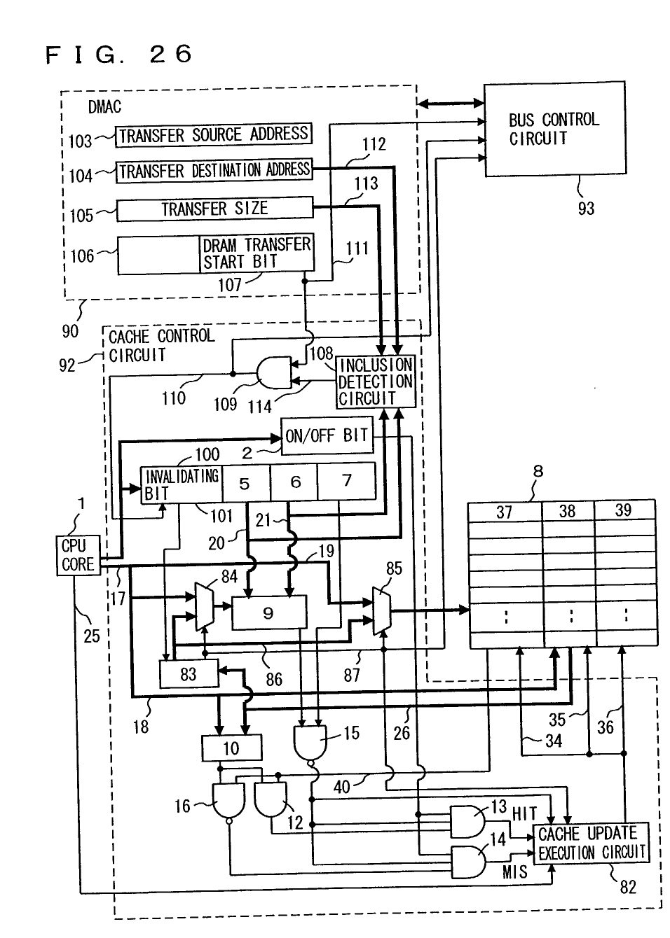

FIG. 26 is a diagram schematically showing a configuration of a system using CPU according to the present invention. In a system configuration shown in FIG. 26, CPU includes CPU core 1, cache entry table 8, and cache controller 92.

CPU further includes a DMA control circuit (DMAC) 90 transferring data between an external memory and an external device in DMA mode (direct memory access mode) through a bus control circuit 93. DMA control circuit 90 performs data transfer between a device other than cache entry table 8 and the external memory or between external devices, independent of the control of CPU core 1.

DMA control circuit 90 includes: a transfer source address setting register 103 storing a transfer source address indicating an address of data of a transfer source in DMA transfer; a transfer destination address setting register 104 storing an address of a data transfer destination; a transfer size setting register 105 storing data indicating a size of transfer data; and a field 107 storing a DMA transfer start bit instructing starting of a DMA transfer.

While DMA control circuit (DMAC) 90 includes a control circuit for controlling DMA transfer, there is not shown a configuration of a section of the control circuit for performing the DMA transfer. DMA control circuit 90 performs transfer of data in a burst mode in data transfer.

Cache control circuit 92 includes: a non-cache region setting register 100 having the same configuration as non-cache region setting register 80 shown in FIG. 24; an inclusion detection circuit 108 receiving a start address set in address designation section 5 and a region size data stored in size designation section 6 included in non-cache region setting register 100, and a transfer destination address and a transfer size data of registers 104 and 105 included in DMA control circuit 90 to detect whether or not an address region of a DMA transfer destination is included in an address region set in non-cache region setting register 100; and an AND circuit 109 receiving an output signal of inclusion detection circuit 108 and a DMA transfer start bit stored in DMA transfer control register 106 to set an invalidating bit in field 101 of non-cache region setting register 100 when a transfer region, in DMA transfer, is completely included in an address region set in non-cache setting register 100.

When an invalidating bit stored in field 101 is set in non-cache region setting register 100, contents of an entry included in a region set in a non-cache region is invalidated in cache entry table 8 (a hold bit is reset or cleared), similar to the fifth embodiment. Therefore, the other components of the configuration of cache control circuit 92 is the same as those of the configuration of the cache control circuit shown in FIG. 24, corresponding components are denoted with the same reference numerals and detailed descriptions thereof will not be repeated.

When DMA transfer is performed, transfer of data is performed between external memory and an external device other than cache entry table 8 under control of DMA control circuit 90, independent of control of CPU (CPU core 1). Therefore, when data transfer to a cache region of the external memory is performed, integrity between stored data in cache entry table 8 and stored data in the external memory could not be retained. Therefore, it is identified by inclusion detection circuit 108 whether or not a DMA transfer region is completely included in an address region set in non-cache register 100, and if completely included, an invalidating bit of field 101 is set to perform invalidation of data in a corresponding address region of cache entry table 8.

Therefore, by storing a DMA transfer region of a cache region in non-cache region setting register 100, invalidation of data in a DMA transfer region in DMA transfer is automatically performed in cache control circuit 92. Therefore, there is no need to consider a DMA transfer region at a program development stage, thereby improving an efficiency in program development.

In this case, there arises a case that DMA transfer is performed being offset from an address region in advance stored in non-cache region setting register 100 depending on contents of processing. For such a case occurs, invalidation of data in a cache region of a DMA region in cache entry table 8 is performed under control of CPU core 1.

Especially, in DMA transfer, by storing a transfer destination address and a transfer size data included in registers 104 and 105 of DMA control circuit 90 into address designation section 5 and size designation section 6, respectively, invalidation of cache of data in a DMA transfer region can be automatically performed by cache control circuit 92. According to such a configuration, invalidation of data of a cache region of DMA transfer region is always performed.

Therefore, at a development stage of a program performing DMA transfer, there is no need of taking into consideration an address region of data stored in cache entry table 8, thereby improving efficiency in program development.

Now, description will be given of an operation in DMA transfer of the system shown in FIG. 26. A transfer source address, a transfer destination address and a transfer size data are stored in respective registers 103 to 105 under control a DMA transfer control section not shown. In address designation section 5 and size designation section 6 of cache region setting register 100, there is stored an address/data indicating a specific address region, which becomes a transfer target region in DMA transfer. An address region set in non-cache region register 100 may be fixedly located in advance or may be set in DMA transfer, according to contents of DMA transfer performed, under control of CPU core 1.

Inclusion detection circuit 108 receives a transfer destination address and a transfer size data stored in registers 104 and 105 of DMA control circuit 90 through signal lines 112 and 113 and receives an address/data stored in address designation section 5 and size designation section 6 from non-cache region setting register 100 through signal lines 20 and 21, and determines whether or not a DMA transfer destination region is completely included in an address region set in non-cache region setting register 100.

Inclusion detection circuit 108 asserts a signal on output signal line 114 to apply a signal at H level to AND circuit 109 when a DMA transfer destination region is completely included in an address region set in non-cache region setting register 100.

When an output signal of AND circuit 109 attains H level, an invalidating bit included field 101 in non-cache region setting register 100 is set and invalidation of data in a set address region of cache entry table 8 is performed by invalidating control circuit 83.

Invalidation processing by invalidating control circuit 83 is the same as processing of invalidating control circuit 83 described in the fifth embodiment. Specifically, entries of cache entry table 8 are sequentially scanned and if an invalidating address generated from a tag address and an entry address is included in an address region set in non-cache region setting register 100, a hold bit of a corresponding entry is reset.

Invalidating control circuit 83 applies a signal indicating invalidation to bus control circuit 93 through a signal line 87 during an invalidating operation. Bus control circuit 93 has acceptance of a DMA transfer request waited for a period when a signal outputted onto a signal line 110 from AND circuit 109 is at H level to indicate that invalidation of cache entry table is necessary and while invalidating control circuit 83 performs invalidation processing.

When invalidating control circuit 83 ends the invalidation, completion of invalidation of data in a set address region of cache entry table 8 is signaled to bus control circuit 93 through signal line 87.

Bus control circuit 93 accepts a DMA transfer request by a DMA transfer start bit when receives an invalidation completion indication through signal line 87, and performs data transfer between the external devices other than cache entry table 8 according to an address and a data size stored in the registers 103 to 105.

When invalidating control circuit 83 performs cache invalidation of an address region, independently of DMA transfer, upon completion of a processing, similarly to the fifth embodiment, the signal on signal line 87 is set in states indicating execution of invalidation and completion of an invalidation. However, in this case, when a DMA transfer start bit is in a deassert state not to instruct DMA transfer, bus control circuit 93 performs no DMA transfer. During DMA transfer, when a cache invalidation is performed after completion of a specific processing, bus control circuit 93 is already under operation of DMA transfer according to the DMA transfer start bit and continues the DMA transfer without any influence of operation of invalidating control circuit 83.

When an output signal of AND circuit 109 is at L level, bus control circuit 93 accepts a DMA transfer request according to a DMA transfer start bit stored in DMA transfer control register 106, to perform DMA transfer in burst mode.

It should be noted that as for a transfer source address set in transfer source address setting register 103, a static random access memory (SRAM), for example, is provided in CPU in addition to cache entry table 8 and when data transfer between the SRAM and the external memory is performed, an address of the SRAM is set in transfer source address setting register 103.

Inclusion detection circuit 18 may be configured to be activated to perform a detection operation when a DMA transfer start bit is set.

Furthermore, a case may be considered where an address region set in advance as a DMA transfer region in non-cache region setting register 100 would merely overlap, in part, an actual DMA transfer address region set by transfer destination address setting register 104 and transfer size setting register 105. In this case, a processing such as a cache invalidation is performed by CPU core 1.

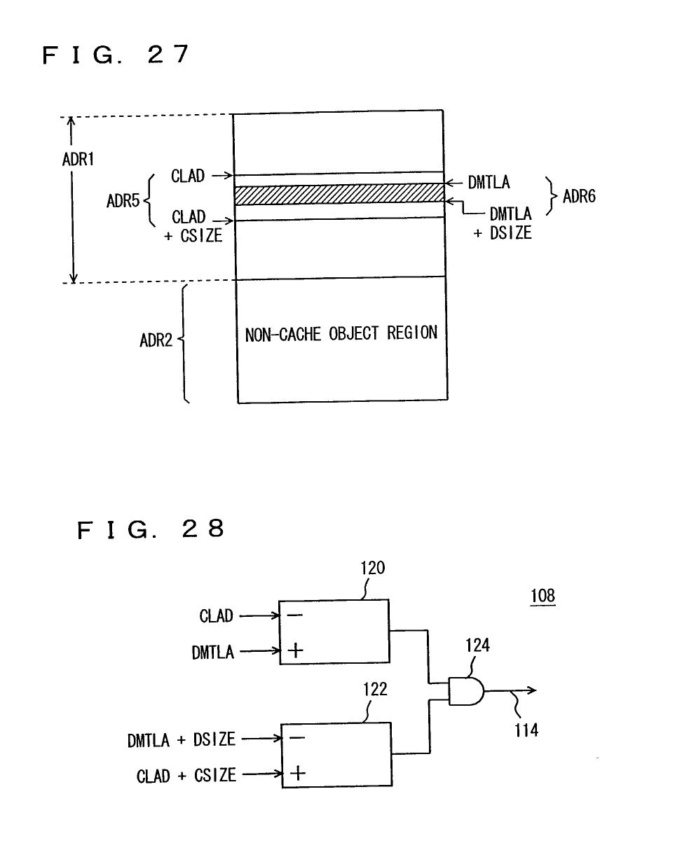

Specifically, as shown in FIG. 27, in a case where an actual DMA transfer address region ADR6 is fully included in an address region ADR5 set in advance as a DMA transfer region in non-cache region setting register 100, invalidation is performed in cache entry table 8.

Address region ADR5 set as a DMA transfer region in non-cache region setting register 100 is determined by a start address CLAD set in address designation section 5 and a size data CSIZE set in size designation section 62. On the other hand, as to an actual DMA transfer address region ADR6, a start address DMTLA thereof is set in transfer destination address setting register 104 and a size DSIZE is set in transfer size setting resister 105. Last addresses of address regions ADR5 and ADR6 are given by addresses CLAD+CSIZE and DMTLA+DSIZE, respectively. An inclusion detection operation is performed in inclusion detection circuit 108 according to the address/data.

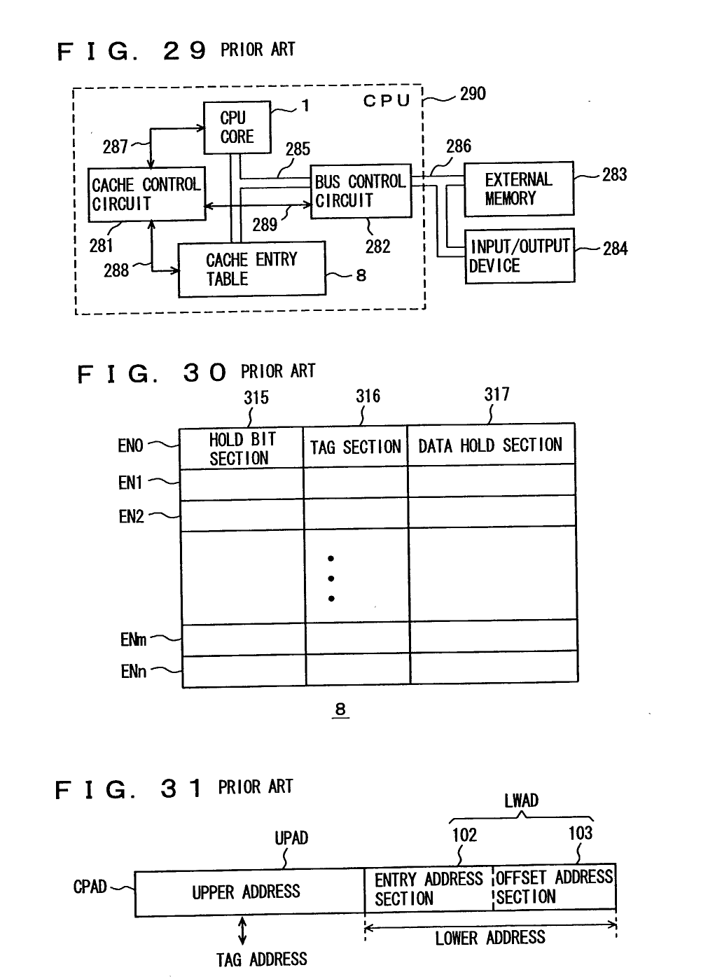

FIG. 28 is a diagram showing an example of a configuration of inclusion detection circuit 108. In FIG. 28, inclusion detection circuit 108 includes: a comparison circuit 120 for comparing start address CLAD stored in non-cache region setting register 100 with start address DMTLA stored in transfer destination address setting register 104; a comparison circuit 122 for comparing last address CLAD+CSIZE of an address set in non-cache region setting register 100 with last address DMTLA+DSIZE of a DMA transfer address region set by registers 104 and 105; and an AND circuit 124 receiving output signals comparison circuits 120 and 122 to output an inclusion detection result indicating signal onto signal line 114.

Comparison circuit 120 outputs a signal at H level when start address DMTLA of a DMA transfer region is equal to or greater than start address CLDA of a set cache address region. Comparison circuit 122 outputs a signal at H level when last address CLAD+CSIZE of a set cache address region is equal to or greater than last address DMTLA+DSIZE of a DMA transfer address region.

AND circuit 124 outputs a signal at H level when output signals of comparison circuits 120 and 122 are both at H level. Therefore, only when a DMA transfer destination address region is included in a set cache address region, a signal at H level is outputted onto signal line 114.

At least one of output signals of comparison circuits 120 and 122 is at L level when an actual DMA transfer address region is present outside or partially overlaps set cache address region ADR5. When an output signal of inclusion detection circuit 105 is at L level in DMA transfer, CPU core 1 is signaled through a path not shown that no invalidation by invalidating control circuit 83 is performed. Responsively, CPU core 1 performs necessary cache invalidation when a DMA transfer address region is a cache object region (this path is not shown).

Therefore, by setting in advance an address region used as a DMA transfer region using address designation section 5 and size designation section 6 in non-cache region setting register 100, even when integrity between data of DMA transfer address region ADR6 of cache object region ADR1 and stored data of cache entry table 8 cannot be held due to DMA transfer, invalidation of cached data is automatically performed prior to DMA transfer under control of cache control circuit 92 by invalidating data of a corresponding address region of cache entry table 8. Therefore, in development of a program including DMA transfer, program development can be performed without taking an address of cached data into account, thereby improving efficiency in program development.

In the sixth embodiment as well, non-cache region setting register 100 and inclusion detection circuit 108 may be provided in plurality. Invalidation of cache entry table 8 is performed according to an address region set in a non-cache region setting register provided corresponding to an inclusion detection circuit outputting a signal at H level.

As described above, according to the present invention, a desired address region of a cache object region is set as a specific processing object region such as a non-cache region. Therefore, a cache object region and a non-cache region can be set according to a system architecture, a size of a cache region can be changed depending on a system architecture and invalidation of data of a processing object region can be performed, achieving a processor system with high flexibility.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A cache memory control circuit for controlling an access to a cache memory operating with an access to a prescribed address space being an operation object, comprising:
a region designation register circuit for storing region designating data designating an address region in said prescribed address space;
a region designation valid bit register circuit for storing a region designation validating bit specifying an address region designated by said region designating data as a designation valid region;
a region determination circuit for determining whether a received address designates an address of the region designated by said region designating data according to the received address and said region designating data; and
control circuitry for controlling an access to said cache memory according to a result of determination by said region determination circuit and said region designation validating bit.

2. The cache memory controller according to claim 1, wherein said control circuitry makes an access to an external bus instead of access to said cache memory when said region determination circuit determines the access is an access to the region designated by said region designating data and said region designation validating bit is set in a state of validating the region designation.

3. The cache memory control circuit according to claim 1, further comprising a write control bit register circuit for storing a write scheme designating bit designating a way of data write in the address region stored in said region designation register circuit,
wherein said control circuitry accesses said cache memory in the way of write designated by said write scheme designating bit in a data write mode of operation when access is made to data in the designated address region of said cache memory.

4. The cache memory control circuit according to claim 3, further comprising a hit/miss determination circuit for determining whether data requested of access is present in said cache memory upon accessing to said cache memory,
wherein said control circuitry accesses said cache memory further according to a result of determination of said hit/miss determination circuit upon accessing to said cache memory,
said region designation valid bit is set in a valid state when the address region designated by said region designating data is set as a non-cache region, and
said write scheme designating bit designates, when said region designation validating bit is set in a state different from said valid state, a data write scheme employed when data requested of access by the received address is present in said cache memory.

5. The cache memory control circuit according to claim 3, further comprising a hit/miss determination circuit for determining whether data requested of access is present in said cache memory upon accessing to said cache memory,
wherein said region designation valid bit is set in a valid state when the address region designated by said region designating data is set as a non-cache region,
said control circuitry accesses said cache memory further according to a result of determination of said hit/miss determination circuit upon accessing to said cache memory,
said write scheme designating bit designates, when said region designation validating bit is set in a state setting the region designated by said region designating data in a state different from said valid state, a data write scheme for said cache memory employed when data requested of access by said received address is absent in said cache memory.

6. The cache memory control circuit according to claim 3, wherein said data write scheme designating bit designates a data write scheme of a default in a state at a first logic level, and designates a data write scheme different from said default when set at a second logic level.

7. The cache memory control circuit according to claim 1, further comprising a sequence designation register circuit for storing an update sequence designating data designating an update sequence of contents of an entry of the address region designated by said region designating data in said cache memory,
wherein said cache memory includes a plurality of entries each including a plurality of data, and in said cache memory, updating of stored data is performed on a basis of the entry when the stored data is updated,
said region designation validating bit is set in a valid state when designation of said region designating data is valid, and
said control circuitry performs updating of contents of an entry at the address requested of access in a sequence designated by said update sequence designating data, when updating of stored data in said cache memory is necessary upon access to said cache memory and when said region designation validating bit is set in a state different from said valid state.

8. The cache memory control circuit according to claim 7, wherein said control circuitry performs updating of contents of a corresponding entry of said cache memory in the designated sequence when data designated by the received address is absent in said cache memory.

9. The cache memory control circuit according to claim 7, wherein each entry of said cache memory includes a plurality of words, and said update sequence designating data designates of a sequence of updating the words.

10. The cache memory control circuit according to claim 1, wherein said region designation validating bit designates invalidation of data in the address region designated by said region designating data when set in a valid state,
said cache memory includes a plurality of entries,
said cache memory control circuit further comprises an invalidation determination control circuit for determining invalidation of data in the address region designated by said region designating data out of data stored in said cache memory on an entry basis when said region designation validating bit is in a valid state, and
said control circuitry invalidates an entry of a corresponding address region of said cache memory according to a result of determination of said invalidation determination control circuit.

11. The cache memory control circuit according to claim 10, wherein each of the entries comprises a data hold section for holding data; a tag address section for storing an address of data stored in said data hold section; and a hold bit section for storing a hold bit indicating whether the data stored in the data hold section is valid,
said invalidation determination control circuit determines whether the address stored in the tag section of each entry of said cache memory is included in the address region designated by said region designating data when said region designation validating bit is in a valid state, and
said control circuitry sets the hold bit of each entry in either of valid and invalid states according to a result of determination of said invalidation determination control circuit.

12. A cache memory control circuit comprising:
a DMA control circuit performing an access to an external memory, and including a source address storage register for storing a source address designating a data transfer source address; a destination address register for storing a transfer destination address designating a transfer destination of data; and a data size register for storing size designating data designating a size of transfer data;
a cache memory for storing data with data in a predetermined address space being an storage object;
a bus control circuit for controlling an operation of transferring data through an external bus according to a DMA transfer request;
a region designating data register for storing a region designating data indicating whether a specific address region in an address region of said cache memory is used as a cache region;
a transfer control circuit, according to stored data in said destination address register and the data size designation data upon generation of the DMA transfer request, for invalidating caching of the address region of the designated transfer destination in said cache memory when the data transfer destination region is included in the address region designated by said region designating data.

13. The cache memory control circuit according to claim 12, wherein said cache memory includes a plurality of entries and stores data in units of entries, and
said transfer control circuit comprises:
a determination circuit for determining whether the transfer destination address region is included in the address region designated by said region designating data; and
an invalidation execution circuit for invalidating data in the region designated by said region designating data in said cache memory according to a result of determination of said determination circuit, and
said invalidation execution circuit executes invalidation of stored data in said cache memory on an entry basis when said determination circuit determines that the transfer destination address region is included in the address region designated by said region designating data.

14. The cache memory control circuit according to claim 13, wherein each entry comprises a data hold section for holding data; a tag address section for storing an address of data stored in said data hold section; and a hold bit section for storing a data bit indicating whether the data stored in said data hold section is valid,
said determination circuit sequentially reads out the address in said tag section and determines whether an address designated by the tag address is included in the address region designated by said region designating data, and
said invalidation execution circuit sets a corresponding hold bit of said cache memory in an invalid state when said determination circuit determines that an address designated by the tag address is included in the designated address region.

15. The cache memory control circuit according to claim 12, wherein said transfer control circuit causes said bus control circuit to delay acceptance of the DMA transfer request till completion of invalidation of caching for the address region at said designated transfer destination.
